(19) United States
(12) Patent Application Publication
(10) Pub. No.: US 2025/0093613 A1
(43) Pub. Date: Mar. 20, 2025

(54) OPTICAL COMPONENT DRIVING APPARATUS AND CAMERA MODULE

(71) Applicant: ALPS ALPINE CO., LTD., Tokyo (JP)

(72) Inventors: Hiroshi OSADA, Tokyo (JP); Changxing WANG, Miyagi (JP); Masanobu MAEDA, Niigata (JP)

(21) Appl. No.: 18/970,279

(22) Filed: Dec. 5, 2024

Related U.S. Application Data
(63) Continuation of application No. PCT/JP2023/008477, filed on Mar. 7, 2023.

(30) Foreign Application Priority Data
Jun. 10, 2022 (JP) 2022-094559

(51) Int. Cl. G02B 7/04; G03B 17/12

(52) U.S. Cl. CPC G02B 7/04; G03B 17/12; G03B 2205/0076

(57) ABSTRACT

An optical component driving apparatus includes a base member, an optical component holding member, a cover member having a top plate facing the base member in the vertical direction, with the optical component holding member interposed therebetween, the cover member having an upper outer peripheral wall part including upper lateral plates extending downward from an outer edge of the top plate, and shape memory alloy wires, wherein the fixed member includes a case member with an open top configured to house the base member, wherein the case member has a bottom plate arranged at a bottom of the base member and a lower outer peripheral wall part including lower lateral plates extending upward from an outer edge of the bottom plate, and wherein the lower lateral plates are positioned between the shape memory alloy wires and the upper lateral plates constituting the upper outer peripheral wall part.

This application is a continuation application of International Application No. PCT/JP2023/008477, filed on Mar. 7, 2023, and designated the U.S., which is based upon and claims priority to Japanese Patent Application No. 2022-094559, filed on Jun. 10, 2022, the entire contents of which are incorporated herein by reference.

### BACKGROUND OF THE INVENTION

### 1. Field of the Invention

The disclosures herein relate to optical component driving apparatuses and camera modules.

### 2. Description of the Related Art

Conventionally, an apparatus to drive a

lens using a shape memory alloy wire in a housing composed of a base member and a cover member has been known (see Patent Literature (PTL) 1).

The shape memory alloy wire used in the above-described apparatus is in a loose state when no current flows. Therefore, for example, when the cover member is assembled to the base member, there is a risk that the shape memory alloy wire is caught between the cover member and the base member. Therefore, it is desirable to provide an optical component driving apparatus capable of preventing the shape memory alloy wire from being pinched between the base member and the cover member.

### CITATION LIST

### Patent Literature

[PTL 1] U.S. Patent Application Publication No. 2018/0149142

### SUMMARY OF THE INVENTION

An optical component driving apparatus according to an embodiment of the present disclosure includes a base member, an optical component holding member provided movably with respect to the base member having an opening penetrating therethrough in a vertical direction, the opening being configured to accommodate an optical component therein, a cover member having a top plate facing the base member in the vertical direction, with the optical component holding member interposed therebetween, the cover member having an upper outer peripheral wall part including a plurality of upper lateral plates extending downward from an outer edge of the top plate, and a plurality of shape memory alloy wires arranged inside the upper outer peripheral wall part, an end of each of which being fixed to a fixed member including the base member, another end of each of which being fixed to a movable member including the optical component holding member, and each of which being configured to move the optical component holding member with respect to the base member, wherein the fixed member includes a case member with an open top configured to house the base member, wherein the case member has a bottom plate arranged at a bottom of the base member and a lower outer peripheral wall part including a plurality of lower lateral plates extending upward from an outer edge of the bottom plate, and wherein the plurality of lower lateral plates are positioned between the plurality of shape memory alloy wires and the plurality of upper lateral plates constituting the upper outer peripheral wall part, and face the plurality of shape memory alloy wires.

The optical component driving apparatus described above can prevent a shape memory alloy wire from being pinched between the base member and the cover member.

### BRIEF DESCRIPTION OF THE DRAWINGS

FIG. 1 is a perspective view of a lens driving apparatus;

FIG. 2 is an exploded perspective view of the lens driving apparatus;

FIG. 3 is a perspective view of the lens holding member to which various members are attached;

FIG. 4 is a perspective view of a base member to which various members are attached;

FIG. 5 is a front view of metal members and shape memory alloy wires;

FIG. 6 is a left side view of the metal members and the shape memory alloy wires;

FIG. 7 is a perspective view of the metal members, flat springs, conductive members, and the shape memory alloy wires;

FIG. 8 is a drawing illustrating an example of a path of a current through the shape memory alloy wires;

FIG. 9 is a drawing illustrating another example of a path of a current through the shape memory alloy wires;

FIG. 10 is a drawing illustrating yet another example of a path of a current through the shape memory alloy wires;

FIG. 11 is a drawing illustrating yet another example of a path of a current through the shape memory alloy wires;

FIG. 12 is a drawing illustrating an example of a path of a current through inner flat springs;

FIG. 13 is a top view of a case member, the metal members, and the base member;

FIG. 14 is a front view of a lens driving apparatus;

FIG. 15 is a left side view of the lens driving apparatus;

FIG. 16 is a top view of a first fixing part of the base member;

FIG. 17 is a top view of a second fixing part of the base member;

FIG. 18 is a front view of the case member, the metal members, and the shape memory alloy wires;

FIG. 19 is a bottom view of the flat springs;

FIG. 20 is a perspective of a workpiece;

FIG. 21 is a perspective view of the flat springs made of the workpiece; and

FIG. 22 is a perspective view of a portion of a removed part constituting the workpiece.

### DESCRIPTION OF THE PREFERRED EMBODIMENT

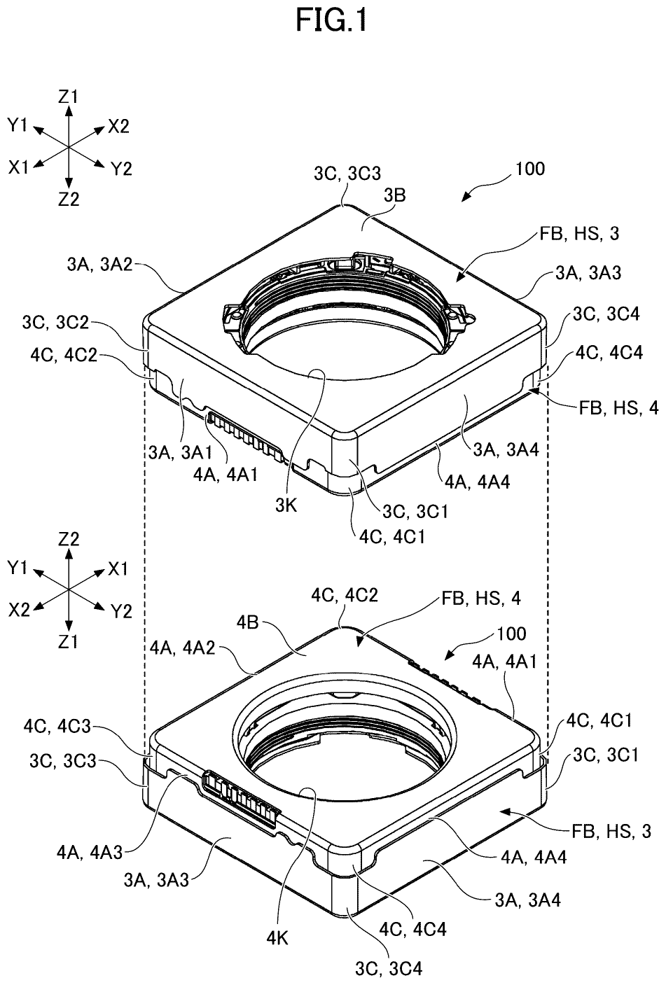

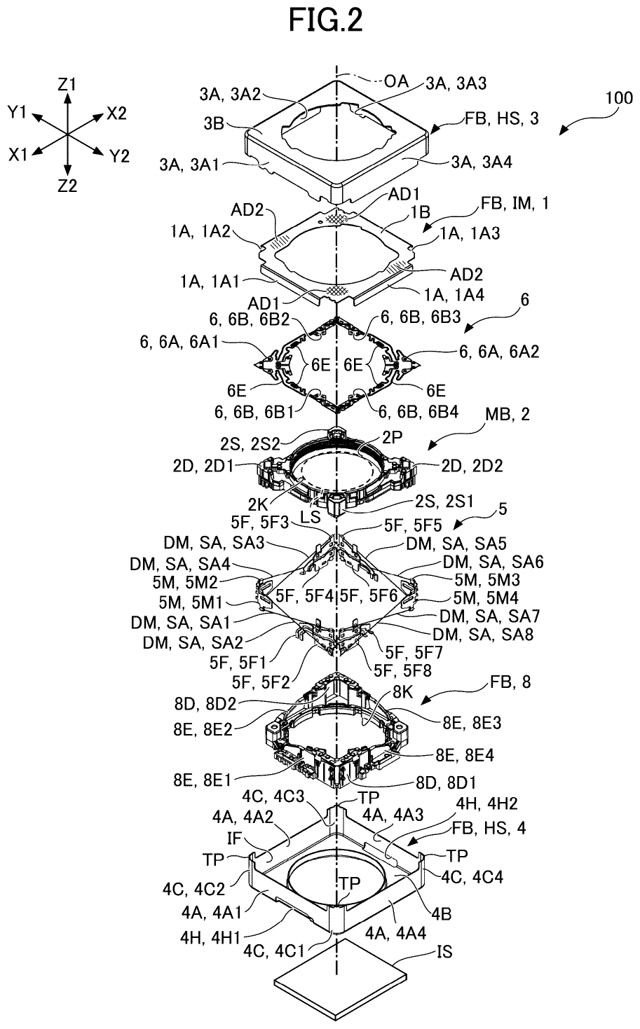

In the following, a lens driving apparatus 100 as an example of an optical component driving apparatus according to an embodiment of the present invention will be described with reference to the accompanying drawings. FIG. 1 is a perspective view of the lens driving apparatus 100. Specifically, a top drawing of FIG. 1 is a top perspective view of the lens driving apparatus 100, and a bottom drawing of FIG. 1 is a bottom perspective view of the lens driving apparatus 100. FIG. 2 is an exploded perspective view of the lens driving apparatus 100.

In FIG. 1, X1 represents one direction of an X-axis constituting a three-dimensional rectangular coordinate system, and X2 represents the other direction of the X-axis. Y1 represents one direction of a Y-axis constituting the three-dimensional rectangular coordinate system, and Y2 represents the other direction of the Y-axis. Z1 represents one direction of a Z-axis constituting the three-dimensional rectangular coordinate system, and Z2 represents the other direction of the Z-axis. In FIG. 1, a center point of the lens driving apparatus 100 is used as a reference, and X1 direction of the lens driving apparatus 100 corresponds to a front (front face) of the lens driving apparatus 100, and X2 direction of the lens driving apparatus 100 corresponds to the rear (rear face) of the lens driving apparatus 100. Y1 direction of the lens driving apparatus 100 corresponds to a left face of the lens driving apparatus 100, and Y2 direction of the lens driving apparatus 100 corresponds to a right face of the lens driving apparatus 100. Z1 direction of the lens driving apparatus 100 corresponds to a top (facing a subject) of the lens driving apparatus 100, and Z2 direction of the lens driving apparatus 100 corresponds to a bottom (facing an imaging sensor) of the lens driving apparatus 100. “Outside” refers to a direction farther than “inside” when viewed from the reference. The same applies to other members in other drawings.

The lens driving apparatus 100 drives a lens body LS, which is an example of an optical component. In FIG. 2, only an outline of the lens body LS is shown with a dashed line for clarity. The lens driving apparatus 100, the lens body LS held by the lens holding member 2 of the lens driving apparatus 100, and the imaging sensor IS arranged so as to face the lens body LS constitute a camera module, which is an example of an optical module. An IR cut filter may be arranged between the lens body LS and the imaging sensor IS. The optical component may be an optical module (camera module). In this case, the optical component driving apparatus functions as an optical module driving apparatus. Alternatively, the optical component may be an imaging sensor IS. In this case, the optical component driving apparatus functions as the imaging sensor driving apparatus.

As shown in FIGS. 1 and 2, the lens driving apparatus 100 includes a cover member 3 and a case member 4. The cover member 3 and the case member 4 are configured to function as a housing HS covering each member. In the illustrated example, the cover member 3 is formed of a nonmagnetic metal, and the case member 4 is formed of a magnetic metal. However, the cover member 3 may be formed of a magnetic metal, and the case member 4 may be formed of a nonmagnetic metal.

The cover member 3 has a substantially rectangular tubular upper outer peripheral wall part 3A, and a substantially rectangular annular flat top plate 3B provided so as to be continuous with an upper end (end in Z1 direction) of the upper outer peripheral wall part 3A. A substantially circular opening 3K is formed in the center of the top plate 3B. In the illustrated example, the top plate 3B is flat and has an even surface, but may have an uneven surface or a step.

The upper outer peripheral wall part 3A includes a first upper lateral plate 3A1 to a fourth upper lateral plate 3A4. The first upper lateral plate 3A1 and a third upper lateral plate 3A3 face each other, and a second upper lateral plate 3A2 and the plate 3A4 face each other. The fourth upper lateral first upper lateral plate 3A1 and the third upper lateral plate 3A3 extend perpendicularly to the second upper lateral plate 3A2 and the fourth upper lateral plate 3A4. The upper outer peripheral wall corner plates 3C located part 3A includes upper between two adjacent upper lateral plates. Specifically, the upper outer peripheral wall part 3A includes a first upper corner plate 3C1 positioned between the first upper lateral plate 3A1 and the fourth upper lateral plate 3A4, a second upper corner plate 3C2 positioned between the first upper lateral plate 3A1 and the second upper lateral plate 3A2, a third upper corner plate 3C3 positioned between the second upper lateral plate 3A2 and the third upper lateral plate 3A3, and a fourth upper corner plate 3C4 positioned between the third upper lateral plate 3A3 and the fourth upper lateral plate 3A4.

The case member 4 has a substantially rectangular tubular lower outer peripheral wall part 4A, and a substantially rectangular annular flat bottom plate 4B provided so as to be continuous with a lower end (end in Z2 direction) of the lower outer peripheral wall part 4A. A substantially circular opening 4K is formed in the center of the bottom plate 4B. In the illustrated example, the bottom plate 4B is flat and has an even surface, but may have an uneven surface or a step.

The lower outer peripheral wall part 4A includes first lower lateral plates 4A1 to fourth lower lateral plates 4A4. The first lower lateral plate 4A1 and the third lower lateral plate 4A3 face each other, and the second lower lateral plate 4A2 and the fourth lower lateral plate 4A4 face each other. The first lower lateral plate 4A1 and the third lower lateral plate 4A3 extend perpendicularly to the second lower lateral plate 4A2 and the fourth lower lateral plate 4A4. The lower outer peripheral wall part 4A includes lower corner plates 4C located between two adjacent lower lateral plates. Specifically, the lower outer peripheral wall part 4A includes a first lower corner plate 4C1 positioned between the first lower lateral plate 4A1 and the fourth lower lateral plate 4A4, a second lower corner plate 4C2 positioned between the first lower lateral plate 4A1 and the second lower lateral plate 4A2, a third lower corner plate 4C3 positioned between the second lower lateral plate 4A2 and the third lower lateral plate 4A3, and a fourth lower corner plate 4C4 positioned between the third lower lateral plate 4A3 and the fourth lower lateral plate 4A4.

The cover member 3 is joined to the case member 4 by an adhesive. The upper outer peripheral wall part 3A is combined with the lower outer peripheral wall part 4A so as to partially cover the lower outer peripheral wall part 4A. The adhesive is a moisture-curable adhesive, a thermosetting adhesive, a light-curable adhesive, or a combination thereof. The same applies to the adhesive described below.

As shown in FIG. 2, the housing HS contains a plate member 1, a lens holding member 2, metal members 5, flat springs 6, a base member 8, shape memory alloy wires SA, and the like.

The movable member MB includes the lens holding member 2 capable of holding the lens body LS. The lens body LS is, for example, a tubular lens barrel having at least one lens, and is configured so that the central axis of the lens barrel extends along the optical axis OA. The fixed member FB includes the plate member 1, the cover member 3, the case member 4, and the base member 8.

The lens holding member 2 is an example of an optical component holding member, and is formed by injection molding of a synthetic resin such as a liquid crystal polymer (LCP). Specifically, as shown in FIG. 2, the lens holding member 2 includes a tubular part 2P formed to extend along the optical axis OA, and movable pedestal parts 2D and protruding parts 2S formed so as to protrude radially outward from the tubular part 2P. In the illustrated example, the lens body LS is configured to be fixed to the inner peripheral surface of the tubular part 2P with the adhesive. That is, the tubular part 2P has an opening 2K penetrating in the vertical direction (Z-axis direction) inside, and at least a portion of the lens body LS is configured to be arranged in the opening 2K.

The movable pedestal parts 2D include a first movable pedestal part 2D1 and a second movable pedestal part 2D2. The first movable pedestal part 2D1 and the second movable pedestal part 2D2 are arranged to protrude in opposite directions with the optical axis OA therebetween. Similarly, the protruding part 2S includes a first protruding part 2S1 and a second protruding part 2S2. The first protruding part 2S1 and the second protruding part 2S2 are arranged to protrude in opposite directions with the optical axis OA therebetween. Specifically, the movable pedestal part 2D and the protruding part 2S are arranged so as to correspond to four corner parts of the lens holding member 2 having a substantially rectangular outer shape in a top view, and are arranged so as to be alternately arranged. A portion of the flat spring 6 is placed on each of the two movable pedestal parts 2D.

The shape memory alloy wire SA is an example of a shape memory actuator. In the illustrated example, the shape memory alloy wires SA include a first wire SA1 to an eighth wire SA8 having substantially the same length and substantially the same diameter. A temperature of the shape memory alloy wire SA rises when an electric current flows, and the shape memory alloy wire SA contracts in accordance with the temperature rise. In an initial state, the shape memory alloy wire SA is in a loosened state. The initial state is a state when no electric power is supplied to the actuator DM and no electric current flows through the shape memory alloy wire SA.

The actuator DM includes the shape memory alloy wires SA. In the illustrated example, the actuator DM can move the lens holding member 2 relative to the base member 8 by utilizing contraction of the shape memory alloy wires SA. In the illustrated example, the actuator DM is configured such that when one or more of the first wire SA1 to the eighth wire SA8 contract, the lens holding member 2 moves, and by the movement, another one or more of the first wire SA1 to the eighth wire SA8 are stretched (extended).

The flat spring 6 is made of, for example, a metal plate mainly made of a copper alloy, a titanium-copper alloy (titanium-copper), or a copper-nickel alloy (nickel-tin-copper). In the illustrated example, the flat springs 6 are made by press working and include outer flat springs 6A and inner flat springs 6B. The outer flat springs 6A include a first outer flat spring 6A1 and a second outer flat spring 6A2. The inner flat springs 6B include a first inner flat spring 6B1 to a fourth inner flat spring 6B4. In the illustrated example, the inner flat springs 6B are separated into four parts (the first inner flat spring 6B1 to fourth inner flat spring 6B4), but at least two of the four parts may be connected.

In the illustrated example, each of the outer flat spring 6A and the inner flat spring 6B is configured to function as a conductive path. Specifically, the outer flat spring 6A is configured to be electrically connected to the shape memory alloy wire SA through a corresponding metal member 5. The inner flat spring 6B is configured to be electrically connected to an electric device such as a variable diaphragm device attached to the lens holding member 2. That is, each of the first inner flat spring 6B1 through the fourth inner flat spring 6B4 is configured to be electrically connected to an electrode terminal of the electric device moving together with the lens holding member 2. A plurality of electric devices may be attached to the lens holding member 2.

The plate member 1 is an example of an insulating member IM that electrically insulates each of the plurality of flat springs 6 (first outer flat spring 6A1, second outer flat spring 6A2, and first inner flat spring 6B1 to fourth inner flat spring 6B4). In the illustrated example, the plate member 1 is a plate-like metal member and is fixed to the lower surface of the top plate 3B of the cover member 3. An insulating coating agent is applied to the lower surface of the plate member 1, which is a surface facing the flat spring 6.

With this configuration, the plate member 1 can prevent contact between the cover member 3 and the flat spring 6. Therefore, the plate member 1 can prevent conduction (short circuit) of two of the plurality of flat springs 6 through the cover member 3.

In the illustrated example, the plate member 1 has an upper plate 1B facing the top plate 3B of the cover member 3, and four bent parts 1A (first bent part 1A1 to fourth bent part 1A4) bent downward from the outer edge of the upper plate 1B. The insulating coating agent is applied to the inner surfaces of the four bent parts 1A (first bent part 1A1 to fourth bent part 1A4).

Each of the four bent parts 1A faces corresponding lateral plates (first upper lateral plate 3A1 to fourth upper lateral plate 3A4) of the cover member 3. Specifically, the first bent part 1A1 faces and contacts the first upper lateral plate 3A1, the second bent part 1A2 faces and contacts the second upper lateral plate 3A2, the third bent part 1A3 faces and contacts the third upper lateral plate 3A3, and the fourth bent part 1A4 faces and contacts the fourth upper lateral plate 3A4.

The plate member 1 is fixed to the lower surface (ceiling surface) of the cover member 3 by the conductive adhesive AD1 and the insulating adhesive AD2. In FIG. 2, the conductive adhesive AD1 is provided with a cross pattern, and the insulating adhesive AD2 is provided with a hatched line pattern for clarity.

The base member 8 is formed by injection molding using a synthetic resin such as a liquid crystal polymer (LCP). In the illustrated example, the base member 8 has a substantially rectangular outline in top view and has an opening 8K in the center. Specifically, the base member 8 has four edges 8E (first edges 8E1 to fourth edges 8E4) arranged so as to surround the opening 8K.

The flat spring 6 is configured to connect the movable pedestal part 2D formed on the lens holding member 2 and the fixed pedestal part 8D formed on the base member 8. The fixed pedestal part 8D includes a first fixed pedestal part 8D1 and a second fixed pedestal part 8D2.

More specifically, the first outer flat spring 6A1 is configured to connect the first movable pedestal part 2D1 formed on the lens holding member 2 and the first fixed pedestal part 8D1 and the second fixed pedestal part 8D2 formed on the base member 8. The second outer flat spring 6A2 is configured to connect the second movable pedestal part 2D2 formed on the lens holding member 2 and the first fixed pedestal part 8D1 and the second fixed pedestal part 8D2 formed on the base member 8.

The first inner flat spring 6B1 is configured to connect the first movable pedestal part 2D1 formed on the lens holding member 2 and the first fixed pedestal part 8D1 formed on the base member 8. The second inner flat spring 6B2 is configured to connect the first movable pedestal part 2D1 formed on the lens holding member 2 and the second fixed pedestal part 8D2 formed on the base member 8. The third inner flat spring 6B3 is configured to connect the second movable pedestal part 2D2 formed on the lens holding member 2 and the second fixed pedestal part 8D2 formed on the base member 8. The fourth inner flat spring 6B4 is configured to connect the second movable pedestal part 2D2 formed on the lens holding member 2 and the first fixed pedestal part 8D1 formed on the base member 8.

The metal member 5 are each configured so that an end of the shape memory alloy wire SA is fixed. In the illustrated example, the metal members 5 include fixed metal members 5F and movable metal members 5M. The fixed metal member 5F forms a portion of the fixed member FB and is configured so as to be fixed to the fixed pedestal part 8D of the base member 8. The movable metal member 5M forms a portion of the movable member MB and is configured so as to be fixed to the movable pedestal part 2D of the lens holding member 2.

More specifically, the fixed metal members 5F are also each referred to as a fixed terminal plate and include a first fixed terminal plate 5F1 to an eighth fixed terminal plate 5F8. The movable metal member 5M, also referred to as a movable terminal plate, includes a first movable terminal plate 5M1 to a fourth movable terminal plate 5M4.

The shape memory alloy wire SA extends

along the inner surface IF of the lower outer peripheral wall part 4A of the case member 4, and is configured so that the movable member MB can be moved relative to the fixed member FB. In the illustrated example, the shape memory alloy wire SA includes a first wire SA1 to an eighth wire SA8, and is configured so that the lens holding member 2 as the movable member MB can be movably supported relative to the base member 8 as the fixed member FB. As shown in FIG. 2, one end of each of the first wire SA1 to the eighth wire SA8 is fixed to the fixed metal member 5F by crimping or welding, and the other end is fixed to the movable metal member 5M by crimping or welding.

The base member 8 is configured so as to function as a wire supporting member to support one end of each of the first wire SAI to the eighth wire

SA8. According to this configuration, in principle, the actuator DM can achieve a six-degree-of-freedom movement of the lens holding member 2 by expanding and contracting each of the first wire SA1 to the eighth wire SA8. The six-degree-of-freedom movement includes translation along the X-axis, translation along the Y-axis, translation along the Z-axis, rotation about the X-axis, rotation about the Y-axis, and rotation about the Z-axis.

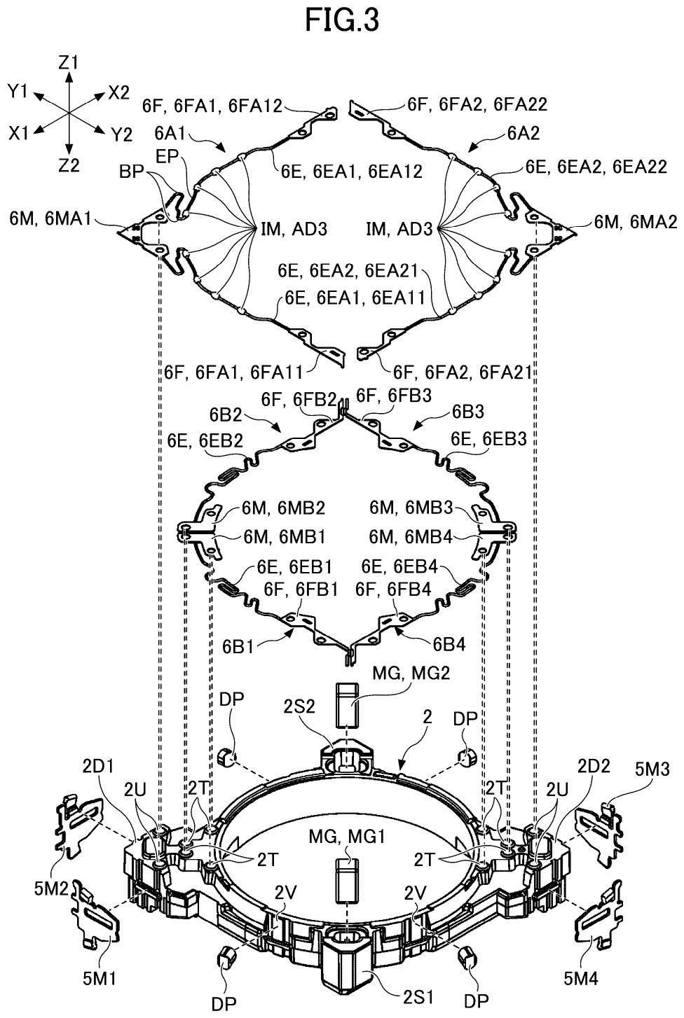

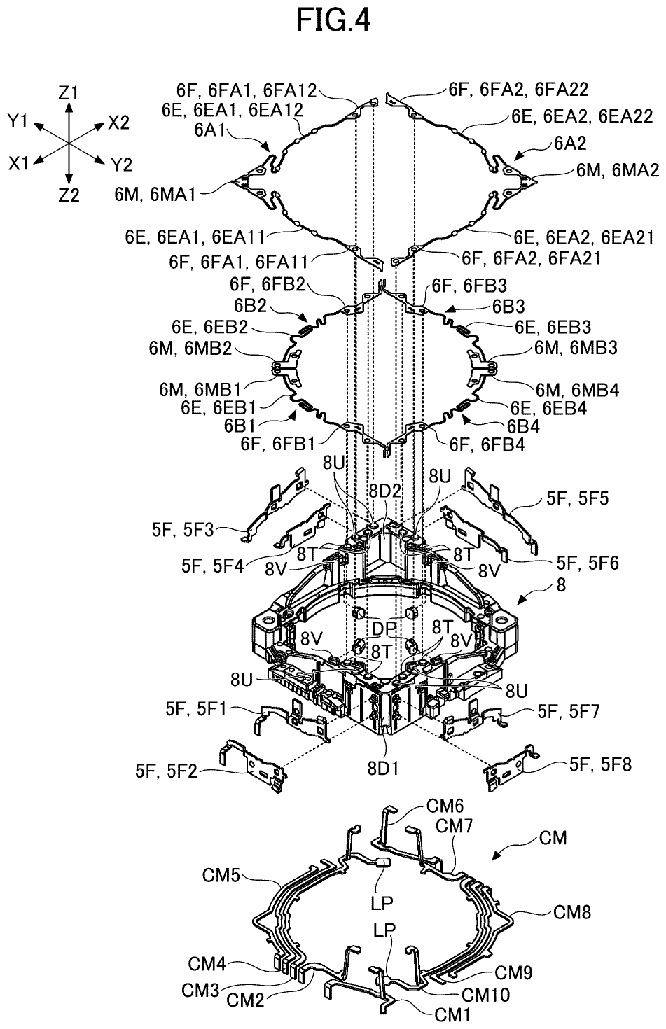

Next, referring to FIGS. 3 and 4, various members attached to the lens holding member 2 and the base member 8 will be described. FIG. 3 is a perspective view of the lens holding member 2 to which various members are attached. FIG. 4 is a perspective view of the base member 8 to which various members are attached.

As shown in FIG. 3, the first movable terminal plate 5M1 is fixed to a wall in X1 direction of the first movable pedestal part 2D1. Specifically, the first movable terminal plate 5M1 is fixed to the first movable pedestal part 2D1 by the adhesive in a state where a prismatic projection formed on the first movable pedestal part 2D1 and protruding outward (X1 direction) is engaged with a rectangular hole formed on the first movable terminal plate 5M1. Similarly, the second movable terminal plate 5M2 is fixed to the wall in Y1 direction of the first movable pedestal part 2D1, the third movable terminal plate 5M3 is fixed to the wall in X2 direction of the second movable pedestal part 2D2, and the fourth movable terminal plate 5M4 is fixed to the wall in Y2 direction of the second movable pedestal part 2D2.

As shown in FIG. 4, the first fixed terminal plate 5F1 and a second fixed terminal plate 5F2 are fixed to the wall in X1 direction of the first fixed pedestal part 8D1. Specifically, the first fixed terminal plate 5F1 and the second fixed terminal plate 5F2 are fixed to the first fixed pedestal part 8D1 by the adhesive. More specifically, the first fixed terminal plate 5F1 is fixed to the first fixed pedestal part 8D1 with the adhesive in such a state that a projection formed on the first fixed pedestal part 8D1 and protruding outward (X1 direction) is engaged with a through-hole formed on the first fixed terminal plate 5F1. The same applies to the second fixed terminal plate 5F2. Similarly, a third fixed terminal plate 5F3 and a fourth fixed terminal plate 5F4 are fixed to the wall in Y1 direction of the second fixed pedestal part 8D2 of the base member 8, a fifth fixed terminal plate 5F5 and a sixth fixed terminal plate 5F6 are fixed to the wall in X2 direction of the second fixed pedestal part 8D2 of the base member 8, and a seventh fixed terminal plate 5F7 and the eighth fixed terminal plate 5F8 are fixed to the wall in Y2 direction of the first fixed pedestal part 8D1 of the base member 8.

As shown in FIG. 4, the base member 8 is embedded with conductive members CM formed of a metal plate containing a material such as copper, iron, or an alloy mainly composed of copper, iron, or the like by insert molding. In the illustrated example, the conductive members CM are formed of a magnetic metal and include a first conductive member CM1 to a tenth conductive members CM10.

A through-hole 4H (see FIG. 2) to expose a terminal part of the conductive member CM is formed in the lower end part of the lower outer peripheral wall part 4A of the case member 4. Specifically, the through-hole 4H includes a first through-hole 4H1 formed in the center of the lower end part of the first lower lateral plate 4A1, and a second through-hole 4H2 formed in the center of the lower end part of the third lower lateral plate 4A3. The first through-hole 4H1 is formed to expose the terminal parts of the first conductive members CM1 to the fifth conductive members CM5, the first fixed terminal plate 5F1, and the second fixed terminal plate 5F2. The second through-holes 4H2 are formed to expose respective terminal parts of the sixth conductive members CM6 to the tenth conductive members CM10, the fifth fixed terminal plate 5F5, and the sixth fixed terminal plate 5F6.

As shown in FIGS. 3 and 4, a damping member DP is mounted between the lens holding member 2 and the base member 8. The damping member DP is a member to reduce vibration of the lens holding member 2. In the illustrated example, the damping member DP is a liquid adhesive applied between a receiving surface 2V (see FIG. 3) formed on the outer wall of the tubular part 2P of the lens holding member 2 and a receiving surface 8V (see FIG. 4) formed on the inner wall of the fixed pedestal part 8D of the base member 8 and gelled by curing or semi-curing.

As shown in FIG. 3, a magnet MG is mounted on the lens holding member 2. The magnet MG is used to position the lens holding member 2 when the lens holding member 2 is in an initial state (initial position). The initial state (initial position) of the lens holding member 2 is a state (position) of the lens holding member 2 when power is not supplied to the actuator DM and no current flows through the shape memory alloy wire SA. The initial state (initial position) of the lens holding member 2 may be a neutral state (neutral position) of the lens holding member 2.

The neutral state of the lens holding member 2 refers to a state in which the lens body LS is positioned in the middle of the movable range in the Z-axis direction when the lens body LS can be translated along the Z-axis direction with respect to the housing HS of the lens driving apparatus 100. Typically, in the neutral state of the lens holding member 2, the lens body LS is positioned in the middle of the movable range in the Z-axis direction. The same applies to the cases where the lens body LS can be translated along the X-axis direction, the lens body LS can be translated along the Y-axis direction, the lens body LS can be rotated around the X-axis, the lens body LS can be rotated around the Y-axis, and the lens body LS can be rotated around the Z-axis. In the illustrated example, the initial position of the lens holding member 2 in the Z-axis direction is different from the neutral position of the lens holding member 2 in the Z-axis direction because the initial position of the lens holding member 2 is positioned on the lowermost (Z2 direction) in the Z-axis direction.

Specifically, in the illustrated example, the magnets MG include the first magnet MG1 accommodated in the recess formed on the upper surface of the first protruding part 2S1, and the second magnet MG2 accommodated in the recess formed on the upper surface of the second protruding part 2S2. The lens holding member 2 is positioned at the neutral position in the X-axis direction and the Y-axis direction by the magnetic attraction force acting between the first magnet MG1 and the positioning plate LP (see FIG. 4) of the tenth conductive member CM10 embedded in the base member 8, and the magnetic attraction force acting between the second magnet MG2 and the positioning plate LP (see FIG. 4) of the third conductive member CM3 embedded in the base member 8. That is, when power is not supplied to the actuator DM, the lens holding member 2 is moved to the neutral position in the X-axis direction and the Y-axis direction by the magnets MG so that the positioning plate LP of the tenth conductive member CM10 and the first magnet MG1 face each other, and the positioning plate LP of the third conductive member CM3 and the second magnet MG2 face each other. However, in the initial state, the lens holding member 2 is not positioned at the neutral position in the Z-axis direction because it is in contact with the upper surface of the base member 8. In the illustrated example, the case member 4 is made of a magnetic metal so that a magnetic attraction force acts between the bottom plate 4B and the magnet MG, that is, the lens holding member 2 can be attracted downward. In contrast, the cover member 3 is made of a nonmagnetic metal so that a magnetic attraction force does not act between the top plate 3B and the magnet MG, that is, the lens holding member 2 cannot be attracted upward.

Each of the plurality of flat springs 6 has a fixed supporting part 6F fixed to the fixed member FB, a movable supporting part 6M fixed to the movable member MB, and an elastically deformable elastic arm 6E provided so as to connect the fixed supporting part 6F and the movable supporting part 6M.

Specifically, the first outer flat spring 6A1 has a fixed supporting part 6FA1 fixed to the fixed pedestal part 8D, a movable supporting part 6MA1 fixed to the movable pedestal part 2D, and an elastic arm 6EA1 connecting the fixed supporting part 6FA1 and the movable supporting part 6MA1. The fixed supporting part 6FA1 includes a fixed supporting part 6FA11 fixed to the first fixed pedestal part 8D1, and a fixed supporting part 6FA12 fixed to the second fixed pedestal part 8D2. The elastic arm 6EA1 includes an elastic arm 6EA11 connecting the fixed supporting part 6FA11 and the movable supporting part 6MA1, and an elastic arm 6EA12 connecting the fixed supporting part 6FA12 and the movable supporting part 6MA1.

The second outer flat spring 6A2 has a fixed supporting part 6FA2 fixed to the fixed pedestal part 8D, a movable supporting part 6MA2 fixed to the movable pedestal part 2D, and an elastic arm 6EA2 connecting the fixed supporting part 6FA2 and the movable supporting part 6MA2. The fixed supporting part 6FA2 includes a fixed supporting part 6FA21 fixed to the first fixed pedestal part 8D1 and a fixed supporting part 6FA22 fixed to the second fixed pedestal part 8D2. The elastic arm 6EA1 includes an elastic arm 6EA21 connecting the fixed supporting part 6FA21 and the movable supporting part 6MA2, and an elastic arm 6EA22 connecting the fixed supporting part 6FA22 and the movable supporting part 6MA2.

A circular through-hole through which a tubular protrusion 8U (see FIG. 4) protruding upward formed on the first fixed pedestal part 8D1 is inserted and a rectangular through-hole used to join the first conductive member CM1 are formed in the fixed supporting part 6FA11. In the illustrated example, the fixing between the fixed supporting part 6FA11 and the protrusion 8U is achieved by performing thermal caulking or cold caulking on the protrusion 8U. However, the fixing between the fixed supporting part 6FA11 and the protrusion 8U may be achieved by the adhesive. The joining between the fixed supporting part 6FA11 and the first conductive member CM1 is achieved by welding such as laser welding. However, the joining between the fixed supporting part 6FA11 and the first conductive member CM1 may be achieved by solder or a conductive adhesive. The same applies to the fixed supporting part 6FA22.

The fixed supporting part 6FA12 is formed with two circular through-holes through which two tubular protrusions 8U protruding upward formed on the second fixed pedestal part 8D2 are inserted. In the illustrated example, the fixing between the fixed supporting part 6FA12 and the protrusion 8U is achieved by performing thermal caulking or cold caulking on the protrusion 8U. However, the fixing between the fixed supporting part 6FA12 and the protrusion 8U may be achieved by the adhesive. The same applies to the fixed supporting part 6FA21.

The movable supporting part 6MA1 is formed with two through-holes through which two tubular protrusions 2U (see FIG. 3) protruding upward formed on the first movable pedestal part 201 are inserted. In the illustrated example, the fixing between the movable supporting part 6MA1 and the protrusion 2U is achieved by applying thermal caulking or cold caulking to the protrusion 2U. However, the fixing between the movable supporting part 6MA1 and the protrusion 2U may be achieved by the adhesive. The same applies to the movable supporting part 6MA2.

The first inner flat spring 6B1 has a fixed supporting part 6FB1 fixed to the first fixed pedestal part 8D1, a movable supporting part 6MB1 fixed to the first movable pedestal part 201, and an elastic arm 6EB1 connecting the fixed supporting part 6FB1 and the movable supporting part 6MB1. The second inner flat spring 6B2 has a fixed supporting part 6FB2 fixed to the second fixed pedestal part 8D2, a movable supporting part 6MB2 fixed to the first movable pedestal part 2D1, and an elastic arm 6EB2 connecting the fixed supporting part 6FB2 and the movable supporting part 6MB2. The third inner flat spring 6B3 has a fixed supporting part 6FB3 fixed to the second fixed pedestal part 8D2, a movable supporting part 6MB3 fixed to the second movable pedestal part 2D2, and an elastic arm 6EB3 connecting the fixed supporting part 6FB3 and the movable supporting part 6MB3. The fourth inner flat spring 6B4 has a fixed supporting part 6FB4 fixed to the first fixed pedestal part 8D1, a movable supporting part 6MB4 fixed to the second movable pedestal part 2D2, and an elastic arm 6EB4 connecting the fixed supporting part 6FB4 and the movable supporting part 6MB4.

The fixed supporting part 6FB1 has circular through-holes through which two tubular protrusions 8T (see FIG. 4) protruding upward formed on the first fixed pedestal part 8D1 are inserted, and a rectangular through-hole used to join the first conductive member CM2. In the illustrated example, the fixing between the fixed supporting part 6FB1 and the protrusion 8T is achieved by performing thermal caulking or cold caulking on the protrusion 8T. However, the fixing between the fixed supporting part 6FB1 and the protrusion 8T may be achieved by the adhesive. The joining between the fixed supporting part 6FB1 and the second conductive member CM2 is achieved by welding such as laser welding. However, the joining between the fixed supporting part 6FB1 and the second conductive member CM2 may be achieved by solder or a conductive adhesive. The same applies to the fixed supporting parts 6FB2 to 6FB4.

The movable supporting part 6MB1 is formed with two through-holes through which two tubular protrusions 2T (see FIG. 3) protruding upward formed on the first movable pedestal part 2D1 are inserted. In the illustrated example, the fixing between the movable supporting part 6MB1 and the protrusion 2T is achieved by applying thermal caulking or cold caulking to the protrusion 2T. However, the fixing between the movable supporting part 6MB1 and the protrusion 2T may be achieved by the adhesive. The same applies to the movable supporting parts 6MB2 to 6MB4.

In FIGS. 3 and 4, the protrusion 2T, the protrusion 2U, the protrusion 8T, and the protrusion 8U are shown in a flattened state after being subjected to thermal caulking. The same applies to other figures. The flattened protrusion 2T, the protrusion 20, the protrusion 8T, and the protrusion 8U are also referred to as “caulking fixed parts”.

The elastic arm 6EA1, the elastic arm 6EA2, and the elastic arms 6EB1 to 6EB4 are elastically deformable arms having a plurality of flexed parts BP. Therefore, the lens holding member 2 is movable with respect to the base member 8 (fixed member FB) not only in the direction parallel to the optical axis OA but also in the direction crossing the optical axis OA.

As shown in FIGS. 3 and 4, the first outer flat spring 6A1 and the second outer flat spring 6A2 have substantially the same shapes. Specifically, the first outer flat spring 6A1 and the second outer flat spring 6A2 are configured to have a two-fold rotational symmetry with respect to the optical axis OA. The first inner flat spring 6B1 and the third inner flat spring 6B3 have substantially the same shapes. Specifically, the first inner flat spring 6B1 and the third inner flat spring 6B3 are configured to have a two-fold rotational symmetry with respect to the optical axis OA. The second inner flat spring 6B2 and the fourth inner flat spring 6B4 have substantially the same shapes. Specifically, the second inner flat spring 6B2 and the fourth inner flat spring 6B4 are configured to have two-fold rotational symmetry with respect to the optical axis OA.

Such a configuration of the flat spring 6 has an effect that the number of components of the lens driving apparatus 100 can be reduced. The flat spring 6 thus configured can support the lens holding member 2 in the air with good balance, and does not adversely affect the weight balance of the movable member MB fixed to each of the eight shape memory alloy wires SA (the first wire SA1 to the eighth wire SA8).

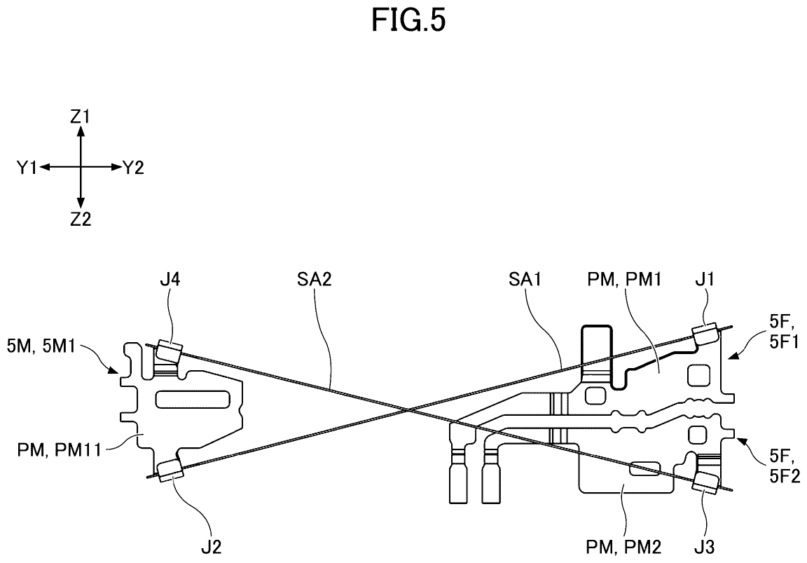

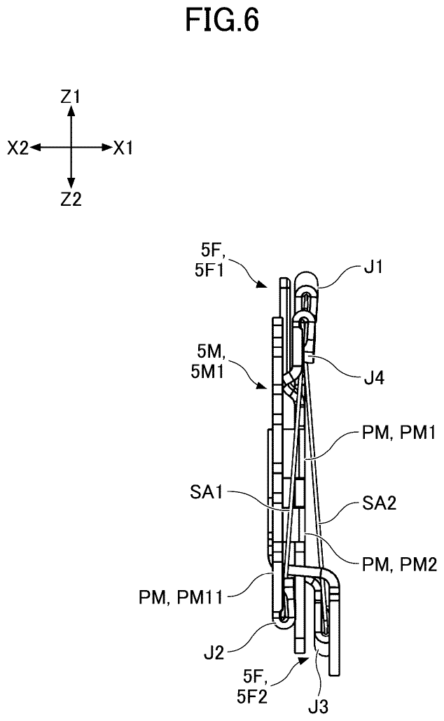

Next, the metal member 5 to which the shape memory alloy wires SA are attached will be described with reference to FIGS. 5 and 6. FIG. 5 is a view of the first wire SAI attached to each of the first movable terminal plate 5M1 and the first fixed terminal plate 5F1 and the second wire SA2 attached to each of the first movable terminal plate 5M1 and the second fixed terminal plate 5F2 when viewed from X1 direction. FIG. 6 is a view of the first wire SA1 attached to each of the first movable terminal plate 5M1 and the first fixed terminal plate 5F1 and the second wire SA2 attached to each of the first movable terminal plate 5M1 and the second fixed terminal plate 5F2 when viewed from Y1 direction. The positional relation of the members shown in FIGS. 5 and 6 corresponds to the positional relation when the lens driving apparatus 100 is assembled. In FIGS. 5 and 6, other members are omitted for clarity. Also, while the following description with reference to FIGS. 5 and 6 relates to the combination of the first wire SA1 and the second wire SA2, the same applies to the combination of the third wire SA3 and the fourth wire SA4, the combination of the fifth wire SA5 and the sixth wire SA6, and the combination of the seventh wire SA7 and the eighth wire SA8.

Specifically, one end of the first wire SA1 is fixed to the first fixed terminal plate 5F1 at a holding part J1 of the first fixed terminal plate 5F1, and the other end of the first wire SA1 is fixed to the first movable terminal plate 5M1 at a holding part J2 on the bottom of the first movable terminal plate 5M1. Similarly, one end of the second wire SA2 is fixed to the second fixed terminal plate 5F2 at a holding part J3 of the second fixed terminal plate 5F2, and the other end of the second wire SA2 is fixed to the first movable terminal plate 5M1 at a holding part J4 on the top of the first movable terminal plate 5M1.

In the illustrated example, the holding part J1 is formed by bending a portion of the first fixed terminal plate 5F1. Specifically, a portion of the first fixed terminal plate 5F1 is bent with one end of the first wire SA1 interposed therebetween to form the holding part J1. One end of the first wire SA1 is fixed to the holding part J1 by welding. The same applies to the holding parts J2 to J4.

The plate-like parts PM of the plurality of metal members 5 are arranged so as to be parallel to each other. In the example shown in FIG. 6, the plate-like part PM1 of the first fixed terminal plate 5F1, the plate-like part PM2 of the second fixed terminal plate 5F2, and the plate-like part PM11 of the first movable terminal plate 5M1 are arranged parallel to each other along the YZ plane. That is, the plate-like part PM1, the plate-like part PM2, and the plate-like part PM11 are arranged parallel to each other along the inner surface IF of the lower outer peripheral wall part 4A.

As shown in FIGS. 5 and 6, the first wire SA1 and the second wire SA2 are arranged so as to have a torsional position relation with each other (to intersect each other in three dimensions when viewed from X1 direction). That is, the first wire SA1 and the second wire SA2 are arranged so as not to contact each other (to be in non-contact).

Specifically, in a front view from X1 direction (see FIG. 5), the first wire SA1 is arranged so that one end (fixed end) thereof is higher than the other end (movable end) thereof, the second wire SA2 is arranged so that the other end (movable end) thereof is higher than the one end (fixed end) thereof, and the first wire SA1 and the second wire SA2 intersect each other. Similarly, in a left side view from Y1 direction, the third wire SA3 is arranged so that one end thereof is higher than the other end thereof, the fourth wire SA4 is arranged so that the other end thereof is higher than the one end thereof, and the third wire SA3 and the fourth wire SA4 intersect each other. In a rear view from X2 direction, the fifth wire SA5 is arranged so that one end thereof is higher than the other end thereof, the sixth wire SA6 is arranged so that the other end thereof is higher than the one end thereof, and the fifth wire SA5 and the sixth wire SA6 intersect each other. In a right side view from Y2 direction, the seventh wire SA7 is arranged so that one end thereof is higher than the other end thereof, the eighth wire SA8 is arranged so that the other end thereof is higher than the one end thereof, and the seventh wire SA7 and the eighth wire SA8 intersect each other.

That is, in the side view, the first wire SA1 to the eighth wire SA8 are arranged to extend obliquely (non-parallel) with respect to the X axis and the Y axis. However, the first wire SA1 and the second wire SA2 need only be arranged to extend obliquely in the front view, and need not intersect each other in the front view. The same applies to the relation between the third wire SA3 and the fourth wire SA4, the relation between the fifth wire SA5 and the sixth wire SA6, and the relation between the seventh wire SA7 and the eighth wire SA8.

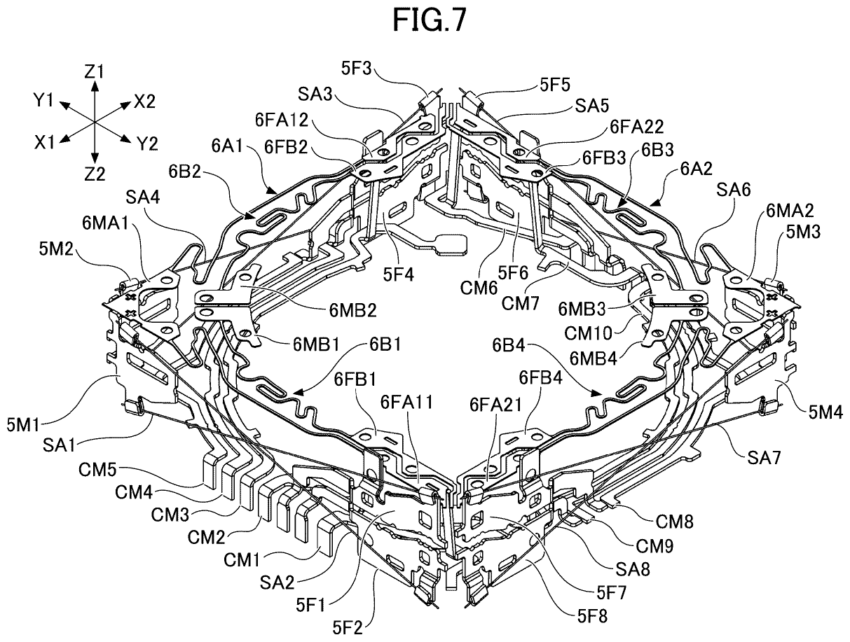

Next, referring to FIG. 7, the positional relation among the metal members 5, the flat springs 6, the conductive members CM, and the shape memory alloy wires SA will be described. FIG. 7 is perspective view of the metal members 5, the flat springs 6, the conductive members CM, and the shape memory alloy wires SA.

The first movable terminal plate 5M1 is vertically joined to the movable supporting part 6MA1 of the first outer flat spring 6A1 by a joining material. The joining material is, for example, solder or a conductive adhesive. That is, the first movable terminal plate 5M1 and the movable supporting part 6MA1 are joined in a state where their surfaces are substantially perpendicular to each other. Similarly, the second movable terminal plate 5M2 is joined vertically to the movable supporting part 6MA1 of the first outer flat spring 6A1 by a joining material, and the third movable terminal plate 5M3 and the fourth movable terminal plate 5M4 are joined vertically to the movable supporting part 6MA2 of the second outer flat spring 6A2 by a joining material.

Conversely, the first fixed terminal plate 5F1 is arranged apart from the fixed supporting part 6FA11 of the first outer flat spring 6A1 and is not in contact with the fixed supporting part 6FA11. Similarly, the third fixed terminal plate 5F3 is arranged apart from the fixed supporting part 6FA12 of the first outer flat spring 6A1 and is not in contact with the fixed supporting part 6FA12. The fifth fixed terminal plate 5F5 is arranged apart from the fixed supporting part 6FA22 of the second outer flat spring 6A2 and is not in contact with the fixed supporting part 6FA22. The seventh fixed terminal plate 5F7 is arranged apart from the fixed supporting part 6FA21 of the second outer flat spring 6A2 and is not in contact with the fixed supporting part 6FA21.

The first conductive member CM1 is joined in parallel to the fixed supporting part 6FA11 by welding such as laser welding at a rectangular through-hole formed in the fixed supporting part 6FA11 of the first outer flat spring 6A1. That is, the first conductive member CM1 and the fixed supporting part 6FA11 are joined in a state where their surfaces are substantially parallel to each other. Similarly, the sixth conductive member CM6 is joined in parallel to the fixed supporting part 6FA22 by welding such as laser welding at a rectangular through-hole formed in the fixed supporting part 6FA22 of the second outer flat spring 6A2.

The second conductive member CM2 is joined in parallel to the fixed supporting part 6FB1 by welding such as laser welding at a rectangular through-hole formed in the fixed supporting part 6FB1 of the first inner flat spring 6B1. The third conductive member CM3 is joined in parallel to the fixed supporting part 6FB2 by welding such as laser welding at a rectangular through-hole formed in the fixed supporting part 6FB2 of the second inner flat spring 6B2. The seventh conductive member CM7 is joined in parallel to the fixed supporting part 6FB3 by welding such as laser welding at a rectangular through-hole formed in the fixed supporting part 6FB3 of the third inner flat spring 6B3. The tenth conductive member CM10 is joined in parallel to the fixed supporting part 6FB4 by welding such as laser welding at a rectangular through-hole formed in the fixed supporting part 6FB4 of the fourth inner flat spring 6B4.

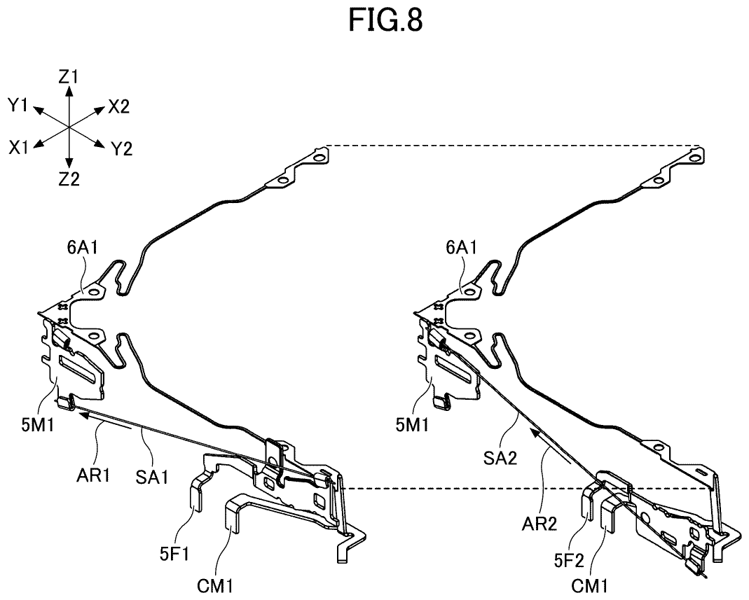

Next, referring to FIGS. 8 to 11, the path of the current flowing through the shape memory alloy wire SA will be described. FIGS. 8 to 11 are perspective views of portions of the configuration shown in FIG. 7.

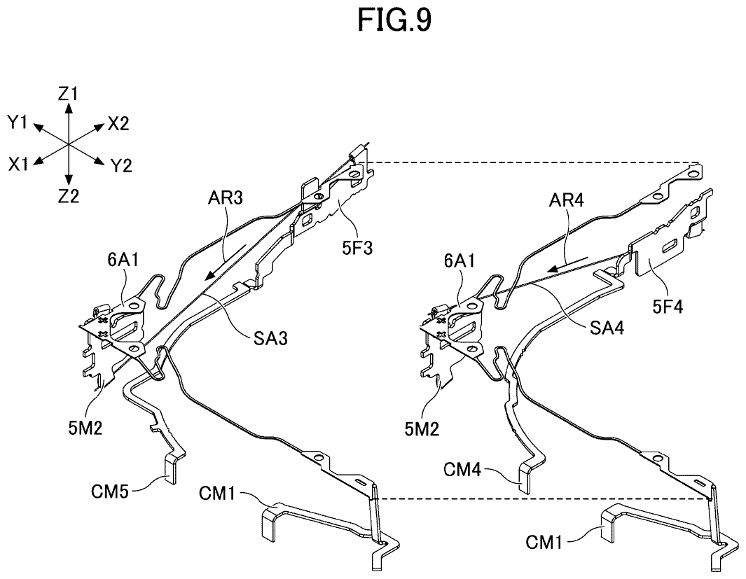

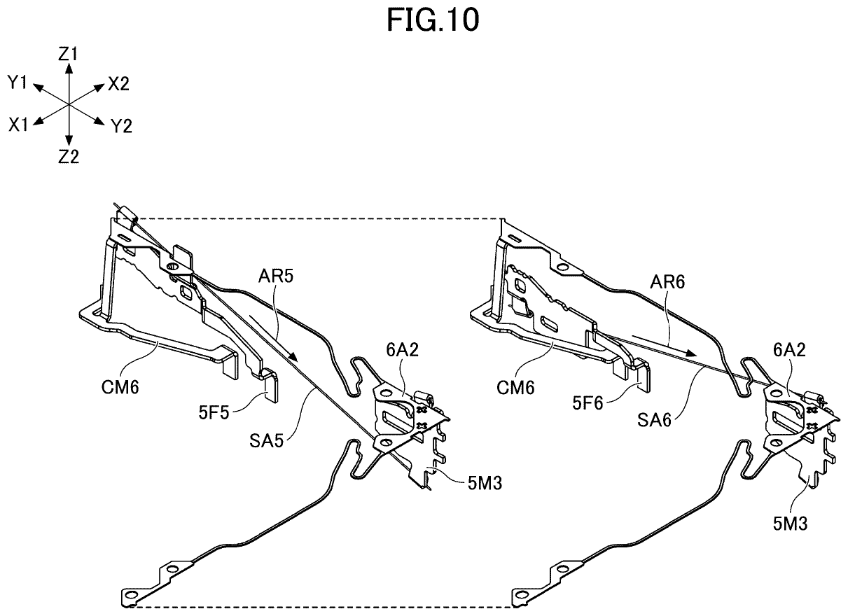

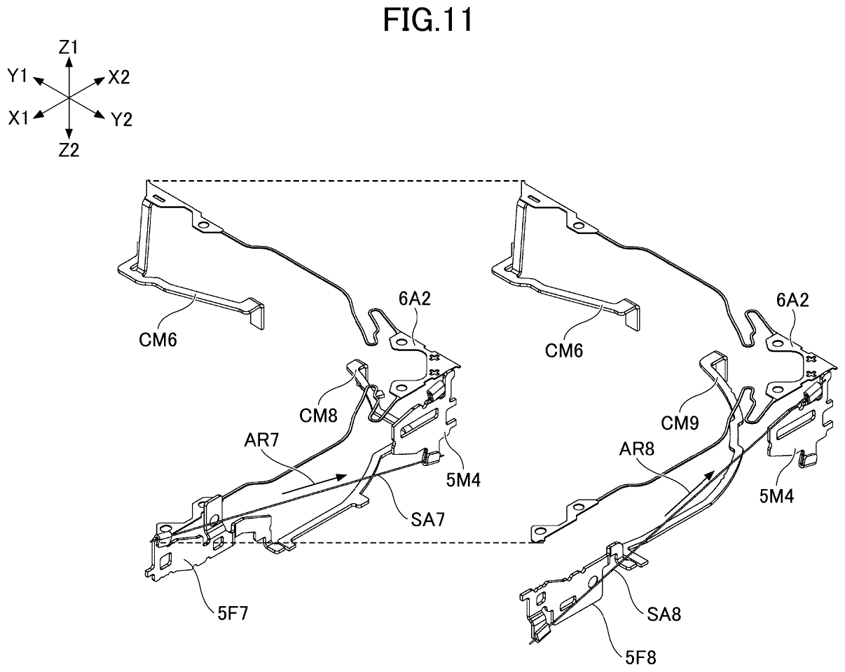

Specifically, the left drawing of FIG. 8 shows a path of the current flowing through the first wire SA1 when the terminal part of the first fixed terminal plate 5F1 is connected to a high potential and the terminal part of the first conductive member CM1 is connected to a low potential, and the right drawing of FIG. 8 shows a path of the current flowing through the second wire SA2 when the terminal part of the second fixed terminal plate 5F2 is connected to a high potential and the terminal part of the first conductive member CM1 is connected to a low potential. The left drawing of FIG. 9 shows a path of the current flowing through the third wire SA3 when the terminal part of the fifth conductive member CM5 is connected to a high potential and the terminal part of the first conductive member CM1 is connected to a low potential. The right drawing of FIG. 9 shows a path of the current flowing through the fourth wire SA4 when the terminal part of the fourth conductive member CM4 is connected to a high potential and the terminal part of the first conductive member CM1 is connected to a low potential. The left drawing of FIG. 10 shows a path of the current flowing through the fifth wire SA5 when the terminal part of the fifth fixed terminal plate 5F5 is connected to a high potential and the terminal part of the sixth conductive member CM6 is connected to a low potential. The right drawing of FIG. 10 shows a path of the current flowing through the sixth wire SA6 when the terminal part of the sixth fixed terminal plate 5F6 is connected to a high potential and the terminal part of the sixth conductive member CM6 is connected to a low potential. The left drawing of FIG. 11 shows a path of the current flowing through the seventh wire SA7 when the terminal part of the eighth conductive member CM8 is connected to a high potential and the terminal part of the sixth conductive member CM6 is connected to a low potential. The right drawing of FIG. 11 shows a path of the current flowing through the eighth wire SA8 when the terminal part of the ninth conductive member CM9 is connected to a high potential and the terminal part of the sixth conductive member CM6 is connected to a low potential.

When the terminal part of the first fixed terminal plate 5F1 is connected to a high potential and the terminal part of the first conductive member CM1 is connected to a low potential, the current flows through the first wire SA1 as indicated by arrow AR1 in the left drawing of FIG. 8. Specifically, the current flows through the first fixed terminal plate 5F1, the first wire SA1, the first movable terminal plate 5M1, and the first outer flat spring 6A1 to the first conductive member CM1.

When the terminal part of the second fixed terminal plate 5F2 is connected to a high potential and the terminal part of the first conductive member CM1 is connected to a low potential, the current flows through the second wire SA2 as indicated by arrow AR2 in the right drawing of FIG. 8. Specifically, the current flows through the second fixed terminal plate 5F2, the second wire SA2, the first movable terminal plate 5M1, and the first outer flat spring 6A1 to the first conductive member CM1.

When the terminal part of the fifth conductive member CM5 is connected to a high potential and the terminal part of the first conductive member CM1 is connected to a low potential, the current flows through the third wire SA3 as indicated by arrow AR3 in the left drawing of FIG. 9. Specifically, the current flows through the fifth conductive member CM5, the third fixed terminal plate 5F3, the third wire SA3, the second movable terminal plate 5M2, and the first outer flat spring 6A1 to the first conductive member CM1. The rear end of the fifth conductive member CM5 is joined to the lower end of the adjacent third fixed terminal plate 5F3 by a bonding material.

When the terminal part of the fourth conductive member CM4 is connected to a high potential and the terminal part of the first conductive member CM1 is connected to a low potential, the current flows through the fourth wire SA4 as indicated by arrow AR4 in the right drawing of FIG. 9. Specifically, the current flows through the fourth conductive member CM4, the fourth fixed terminal plate 5F4, the fourth wire SA4, the second movable terminal plate 5M2, and the first outer flat spring 6A1 to the first conductive member CM1. The rear end of the fourth conductive member CM4 is joined to the lower end of the adjacent fourth fixed terminal plate 5F4 by a bonding material.

When the terminal part of the fifth fixed terminal plate 5F5 is connected to a high potential and the terminal part of the sixth conductive member CM6 is connected to a low potential, the current flows through the fifth wire SA5 as indicated by arrow AR5 in the left drawing of FIG. 10. Specifically, the current flows through the fifth fixed terminal plate 5F5, the fifth wire SA5, the third movable terminal plate 5M3, and the second outer flat spring 6A2 to the sixth conductive member CM6.

When the terminal part of the sixth fixed terminal plate 5F6 is connected to a high potential and the terminal part of the sixth conductive member CM6 is connected to a low potential, the current flows through the sixth wire SA6 as indicated by arrow AR6 in the right drawing of FIG. 10. Specifically, the current flows through the sixth fixed terminal plate 5F6, the sixth wire SA6, the third movable terminal plate 5M3, and the second outer flat spring 6A2 to the sixth conductive member CM6.

When the terminal part of the eighth conductive member CM8 is connected to a high potential and the terminal part of the sixth conductive member CM6 is connected to a low potential, the current flows through the seventh wire SA7 as indicated by arrow AR7 in the left drawing of FIG. 11. Specifically, the current flows through the eighth conductive member CM8, the seventh fixed terminal plate 5F7, the seventh wire SA7, the fourth movable terminal plate 5M4, and the second outer flat spring 6A2 to the sixth conductive member CM6. The front end of the eighth conductive member CM8 is joined to the lower end of the adjacent seventh fixed terminal plate 5F7 by a bonding material.

When the terminal of the ninth conductive member CM9 is connected to a high potential and the terminal of the sixth conductive member CM6 is connected to a low potential, the current flows through the eighth wire SA8 as indicated by arrow AR8 in the right drawing of FIG. 11. Specifically, the current flows through the ninth conductive member CM9, the eighth fixed terminal plate 5F8, the eighth wire SA8, the fourth movable terminal plate 5M4, and the second outer flat spring 6A2 to the sixth conductive member CM6. The front end of the ninth conductive member CM9 is joined to the lower end of the adjacent eighth fixed terminal plate 5F8 by a bonding material.

In the illustrated example, the paths of the currents flowing through the first wire SA1 to the fourth wire SA4 partially coincide. Specifically, the paths of the four currents coincide at a portion passing through the first outer flat spring 6A1 and the first conductive member CM1. Similarly, the paths of the currents flowing through the fifth wire SA5 to the eighth wire SA8 partly coincide. Specifically, the paths of the four currents coincide at a portion passing through the second outer flat spring 6A2 and the sixth conductive member CM6. This configuration has the effect that the number of components can be reduced. The direction of the current flowing through the first wire SA1 to the eighth wire SA8 may be opposite to the direction indicated by the arrow.

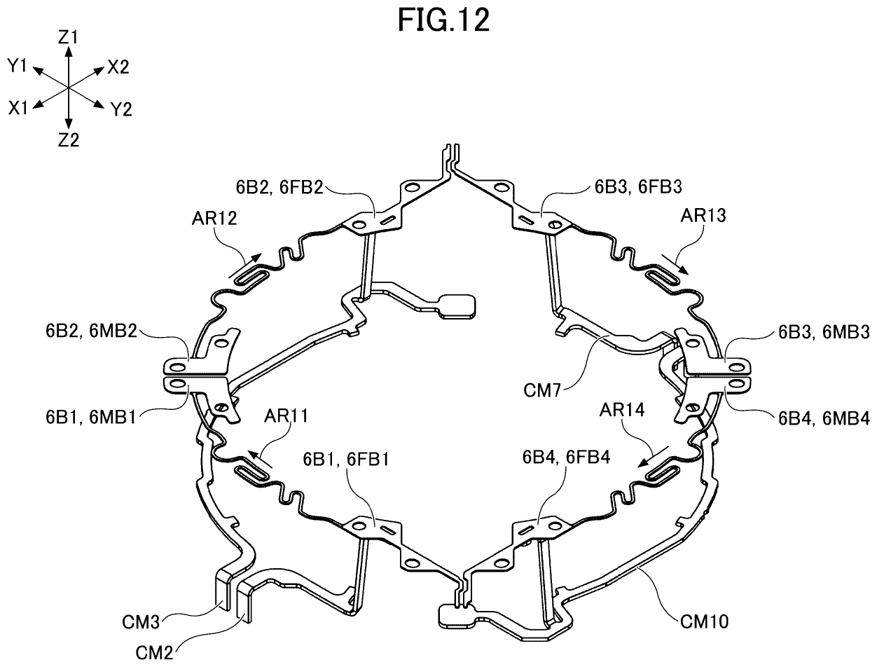

Next, referring to FIG. 12, a path of the current flowing through the inner flat spring 6B when power is supplied to an electric device such as a variable diaphragm device attached to the lens holding member 2 will be described. FIG. 12 is a perspective view of a portion of the configuration shown in FIG. 7.

When the terminal part of the second conductive member CM2 is connected to a high potential and the terminal part of the third conductive member CM3 is connected to a low potential, the current flows from the second conductive member CM2 through the first inner flat spring 6B1 to the electric device as indicated by the arrow AR11. The current from the electric device flows through the second inner flat spring 6B2 to the third conductive member CM3 as indicated by the arrow AR12. Specifically, the current flows through the second conductive member CM2, the fixed supporting part 6FB1, the movable supporting part 6MB1, the electric device, the movable supporting part 6MB2, and the fixed supporting part 6FB2 to the third conductive member CM3.

When the terminal part of the seventh conductive member CM7 is connected to a high potential and the terminal part of the tenth conductive member CM10 is connected to a low potential, the current flows from the seventh conductive member CM7 through the third inner flat spring 6B3 to the electrical device as indicated by the arrow AR13. The current from the electrical device flows through the fourth inner flat spring 6B4 to the tenth conductive member CM10 as indicated by the arrow AR14. Specifically, the current flows through the seventh conductive member CM7, the fixed supporting part 6FB3, the movable supporting part 6MB3, the electrical device, the movable supporting part 6MB4, and the fixed supporting part 6FB4 to the tenth conductive member CM10.

The same applies when a current flows from the second conductive member CM2 to the seventh conductive member CM7 or the tenth conductive member CM10, when a current flows from the third conductive member CM3 to the second conductive member CM2, the seventh conductive member CM7, or the tenth conductive member CM10, when a current flows from the seventh conductive member CM7 to the second conductive member CM2 or the third conductive member CM3, or when a current flows from the tenth conductive member CM10 to the second conductive member CM2, the third conductive member CM3, or the seventh conductive member CM7.

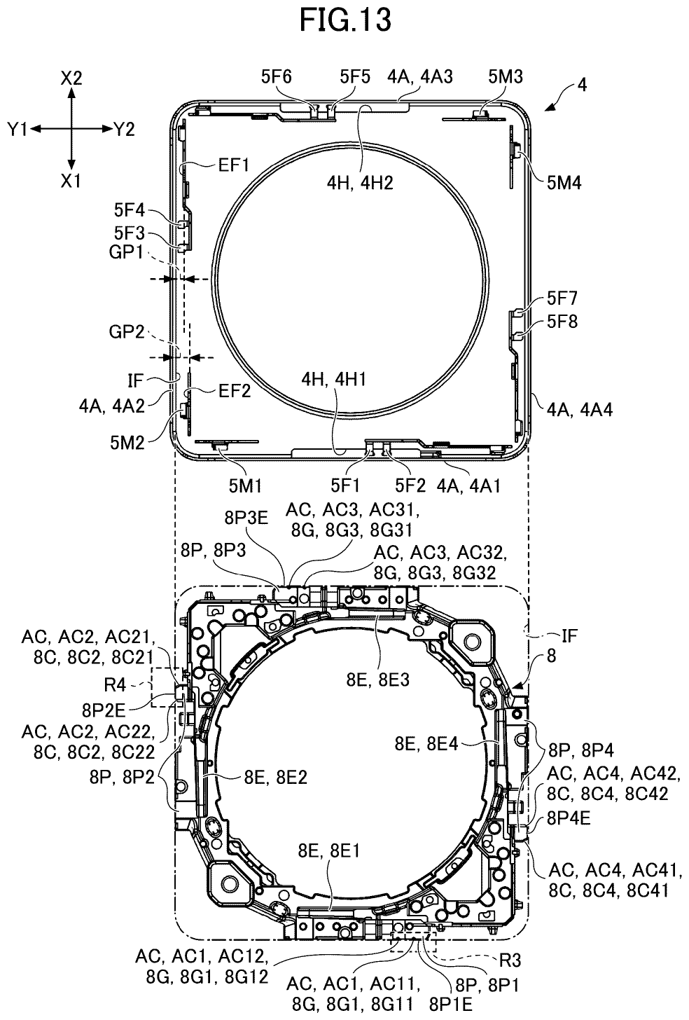

Next, referring to FIG. 13, the positional relation among the case member 4, the metal members 5, and the base member 8 will be described. FIG. 13 is a top view of the case member 4, the metal members 5, and the base member 8. Specifically, the top drawing of FIG. 13 is a top view of the case member 4 and the metal members 5, and the bottom drawing of FIG. 13 is a top view of the base member 8. In FIG. 13, members other than the case member 4, the metal members 5, and the base member 8 are omitted for clarity. Further, in the bottom drawing of FIG. 13, the inner surface IF of the lower outer peripheral wall part 4A of the case member 4 is shown with a long dashed short dashed line for clarity. The top drawing of FIG. 13 is a top view showing the position of the movable metal members 5M when the lens holding member 2 is in the neutral state or the initial state. Thus, the lens driving apparatus 100 is configured so that the neutral position and the initial position of the lens holding member 2 are the same in the X-axis direction and the Y-axis direction.

As shown in the top drawing of FIG. 13, the first fixed terminal plate 5F1 to the eighth fixed terminal plate 5F8 and the first movable terminal plate 5M1 to the fourth movable terminal plate 5M4 are arranged at positions separated by a predetermined interval from the inner surface IF of the lower outer peripheral wall part 4A of the case member 4.

Specifically, the outer surface EF1 of the plate-like parts PM of the third fixed terminal plate 5F3 and the fourth fixed terminal plate 5F4 are arranged at positions separated by a distance GP1 from the inner surface IF of the lower outer peripheral wall part 4A (the second lower lateral plate 4A2). The same applies to the first fixed terminal plate 5F1, the second fixed terminal plate 5F2, and the plate-like parts PM of the fifth fixed terminal plate 5F5 to the eighth fixed terminal plate 5F8. The outer surface EF2 of the plate-like parts PM of the second movable terminal plate 5M2 is arranged at positions separated by a distance GP2 from the inner surface IF of the lower outer peripheral wall part 4A (the second lower lateral plate 4A2). The distance GP2 is larger than the distance GP1. The same applies to the plate-like parts PM of the first movable terminal plate 5M1, the third movable terminal plate 5M3, and the fourth movable terminal plate 5M4.

That is, the plate-like parts PM of the eight fixed metal members 5F (the first fixed terminal plate 5F1 to the eighth fixed terminal plate 5F8) are disposed closer to the inner surface IF of the lower outer peripheral wall part 4A of the case member 4 than the plate-like parts PM of the four movable metal members 5M (the first movable terminal plate 5M1 to the fourth movable terminal plate 5M4).

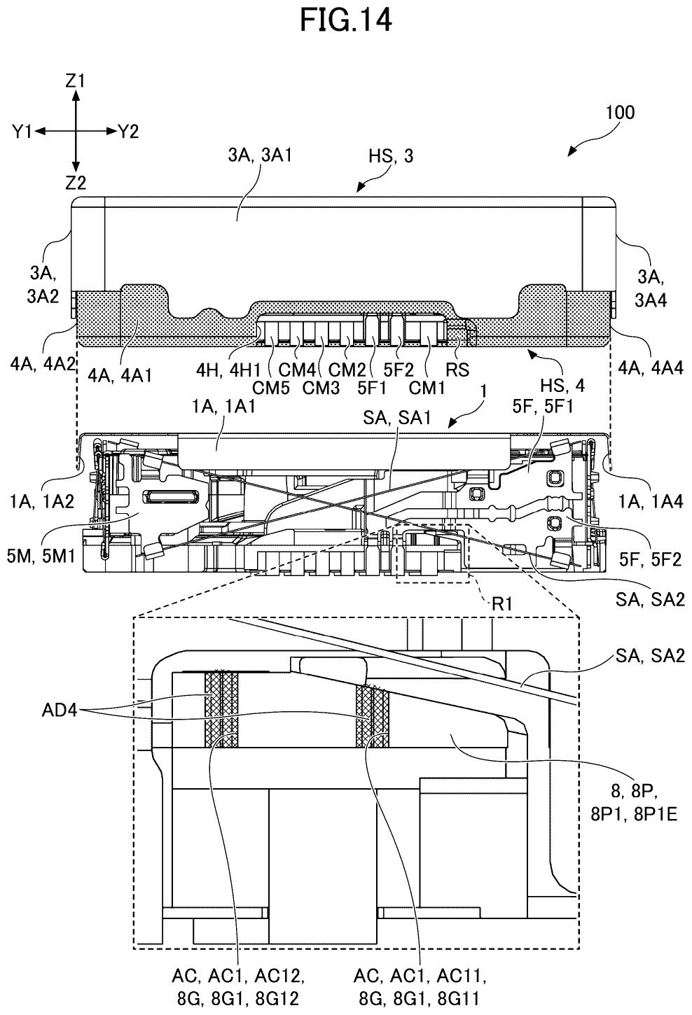

As shown in the bottom drawing of FIG. 13, the four edges 8E (the first edge 8E1 to the fourth edge 8E4) of the base member 8 are disposed so as to be bonded and fixed to the inner surface IF of the lower outer peripheral wall part 4A of the case member 4 via the adhesive AD4 (see FIGS. 14 to 17) at the fixing part 8P (the first fixed part 8P1 to the fourth fixed part 8P4).

Specifically, the fixing part 8P is formed so as to protrude outward from the outer peripheral surface of the edge 8E. In the illustrated example, the fixing part 8P includes a first fixing part 8P1 protruding from the outer peripheral surface of the first edge 8E1 toward X1, a second fixing part 8P2 protruding from the outer peripheral surface of the second edge 8E2 toward Y1, a third fixing part 8P3 protruding from the outer peripheral surface of the third edge 8E3 toward X2, and a fourth fixing part 8P4 protruding from the outer peripheral surface of the fourth edge 8E4 toward Y2.

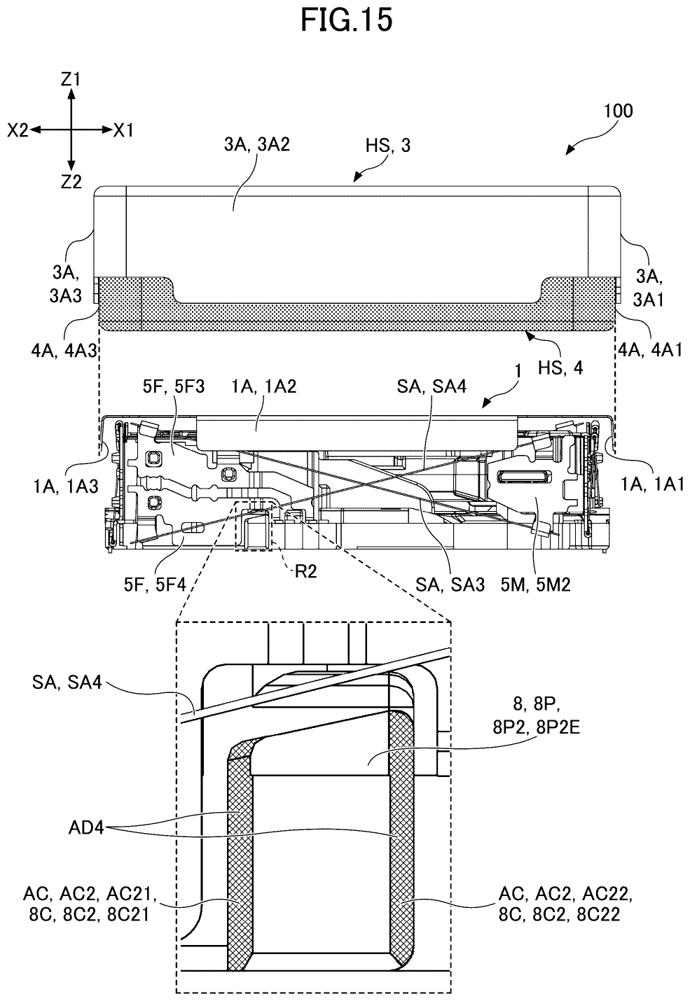

Next, referring to FIGS. 13 to 15, the adhesive reservoir AC formed on the outer surface of the fixing part 8P will be described. FIG. 14 is a front view of the lens driving apparatus 100. More specifically, the top drawing of FIG. 14 is a front view of the lens driving apparatus 100 in a state where the housing HS composed of the cover member 3 and the case member 4 is attached. The middle drawing of FIG. 14 is a front view of the lens driving apparatus 100 in a state where the housing HS is removed. The bottom drawing of FIG. 14 is an enlarged view of a range R1 surrounded by dashed lines in the middle drawing of FIG. 14. FIG. 15 is a left side view of the lens driving apparatus 100. More specifically, the top drawing of FIG. 15 is a left side view of the lens driving apparatus 100 in a state where the housing HS is attached. The middle drawing of FIG. 15 is a left side view of the lens driving apparatus 100 in a state where the housing HS is removed. The bottom drawing of FIG. 15 is an enlarged view of the area R2 surrounded by dashed lines in the middle drawing of FIG. 15.

The adhesive reservoir AC is a space where the adhesive AD4 to bond the case member 4 and the base member 8 is stored. Specifically, the adhesive reservoir AC includes a front adhesive reservoir AC1, a left adhesive reservoir AC2, a rear adhesive reservoir AC3, and a right adhesive reservoir AC4, as shown in FIG. 13. More specifically, the front adhesive reservoir AC1 a includes first front adhesive reservoir AC11 and a second front adhesive reservoir AC12, the left adhesive reservoir AC2 includes a first left adhesive reservoir AC21 and a second left adhesive reservoir AC22, the rear adhesive reservoir AC3 includes a first rear adhesive reservoir AC31 and a second rear adhesive reservoir AC32, and the right adhesive reservoir AC4 includes a first right adhesive reservoir AC41 and a second right adhesive reservoir AC42.

The front adhesive reservoir AC1 is formed on an outer surface 8P1E of the first fixing part 8P1 of the base member 8. Specifically, as shown in FIG. 14, the outer surface 8P1E is formed with a groove 8G (front groove 8G1) that functions as the front adhesive reservoir AC1. The front groove 8G1 includes a first front groove 8G11 and a second front groove 8G12.

The outer surface 8P1E of the first fixing part 8P1 is a plane that is bonded and fixed to the inner surface IF of the lower outer peripheral wall part 4A (first lower lateral plate 4A1) via the adhesive AD4, and is configured to extend parallel to the inner surface IF.

In the illustrated example, the front groove 8G1 is a space having a substantially semicircular cross section that is formed to extend along the Z-axis direction. The adhesive AD4 applied to the lower end part of the outer surface 8P1E through the first through-hole 4H1 moves upward in the front groove 8G1 covered by the lower outer peripheral wall part 4A (the first lower lateral plate 4A1) by capillary action and reaches the upper end portion of the first fixing part 8P1 as shown in the bottom drawing of FIG. 14. In the bottom drawing of FIG. 14, the adhesive AD4 is provided with a cross pattern for clarity.

The left adhesive reservoir AC2 (see the bottom drawing of FIG. 13) is formed on the outer surface 8P2E of the second fixing part 8P2 of the base member 8. Specifically, as shown in FIG. 15, an inclined part 8C (left inclined part 8C2) functioning as the left adhesive reservoir AC2 is formed on the outer surface 8P2E. The left inclined part 8C2 includes a first left inclined part 8C21 and a second left inclined part 8C22.

The outer surface 8P2E of the second fixing part 8P2 is a plane that is bonded and fixed to the inner surface IF of the lower outer peripheral wall part 4A (second lower lateral plate 4A2) via the adhesive AD4, and is configured to extend parallel to the inner surface IF.

In the illustrated example, the left inclined part 8C2 is a space having a substantially triangular cross-section formed to extend along the Z-axis direction. When the base member 8 is installed in the case member 4, the adhesive AD4 applied to the inner bottom surface or the inner surface IF of the case member 4 moves upward by capillary action in the left inclined part 8C2 covered by the lower outer peripheral wall part 4A (the second lower lateral plate 4A2) and reaches the upper end of the second fixing part 8P2 as shown in the bottom drawing of FIG. 15. In the bottom drawing of FIG. 15, the adhesive AD4 is provided with a cross pattern for clarity.

The rear adhesive reservoir AC3 (see the bottom drawing of FIG. 13) is formed on the outer surface 8P3E of the third fixing part 8P3 of the base member 8. Specifically, the outer surface 8P3E is formed with a groove 8G (rear groove 8G3) that functions as the rear adhesive reservoir AC3. The rear groove 8G3 includes a first rear groove 8G31 and a second rear groove 8G32.

The outer surface 8P3E of the third fixing part 8P3 is a plane that is bonded and fixed to the inner surface IF of the lower outer peripheral wall part 4A (the third lower lateral plate 4A3) through the adhesive AD4, and is configured to extend parallel to the inner surface IF.

In the illustrated example, the rear groove 8G3 is a space having a substantially semicircular cross-section formed to extend along the Z-axis direction. The adhesive AD4 applied to the lower end part of the outer surface 8P3E through the second through-hole 4H2 moves upward by capillary action in the rear groove 8G3 covered by the lower outer peripheral wall part 4A (the third lower lateral plate 4A3) and reaches the upper end of the third fixing part 8P3.

The right adhesive reservoir AC4 (see the bottom drawing of FIG. 13) is formed on the outer surface 8P4E of the fourth fixing part 8P4 of the base member 8. Specifically, an inclined part 8C (the right inclined part 8C4) functioning as the right adhesive reservoir AC4 is formed on the outer surface 8P4E. The right inclined part 8C4 includes the first right inclined part 8C41 and the second right inclined part 8C42.

The outer surface 8P4E of the fourth fixing part 8P4 is a plane that is bonded and fixed to the inner surface IF of the lower outer peripheral wall part 4A (the fourth lower lateral plate 4A4) via the adhesive AD4, and is configured to extend parallel to the inner surface IF.

In the illustrated example, the right inclined part 8C4 is a space having a substantially triangular cross-section formed to extend along the Z-axis direction. When the base member 8 is installed in the case member 4, the adhesive AD4 applied to the inner bottom surface or the inner surface IF of the case member 4 moves upward by capillary action in the right inclined part 8C4 covered by the lower outer peripheral wall part 4A (the fourth lower lateral plate 4A4) and reaches the upper end of the fourth fixing part 8P4.

As described above, the adhesive AD4 spread between the lower outer peripheral wall part 4A of the case member 4 and the fixing part 8P of the base member 8 can firmly bond and fix the case member 4 and the base member 8.

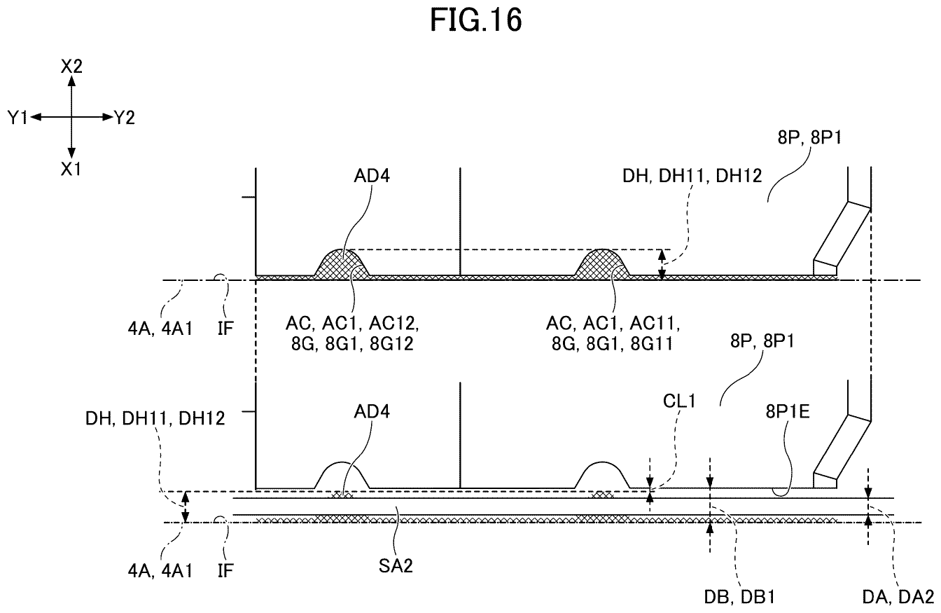

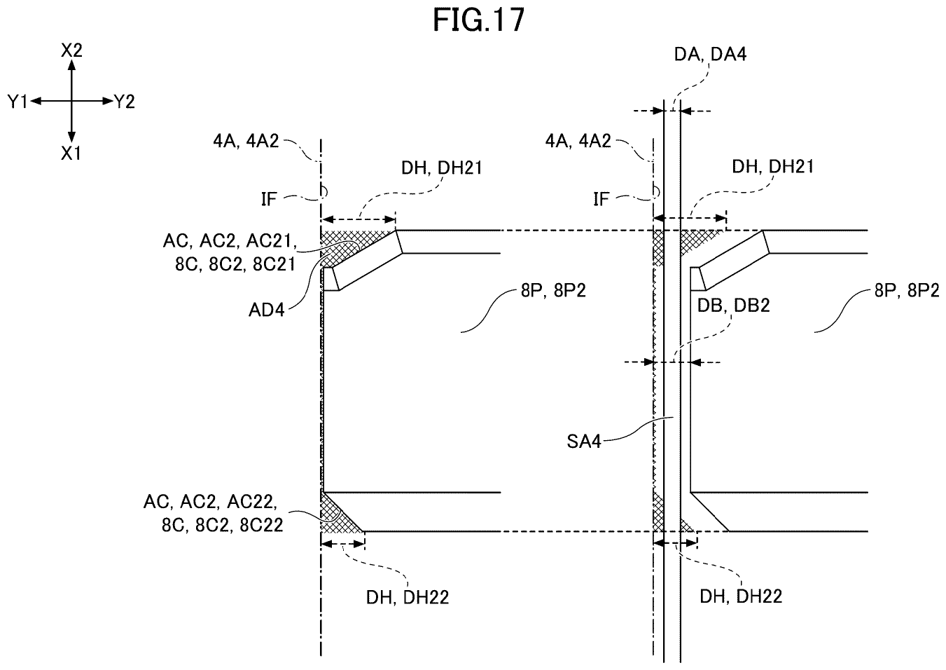

Next, referring to FIGS. 16 and 17, an effect produced by the adhesive reservoir AC will be described. FIG. 16 is an enlarged view of the area R3 surrounded by dashed lines in the bottom drawing of FIG. 13. Specifically, the top drawing of FIG. 16 shows a state before the inner surface IF of the case member 4 and the first fixing part 8P1 are separated by an impact or the like, and the bottom drawing of FIG. 16 shows a state when the inner surface IF of the case member 4 and the first fixing part 8P1 are separated by the impact or the like. FIG. 17 is an enlarged view of the area R4 surrounded by dashed lines in the bottom drawing of FIG. 13. Specifically, the left drawing of FIG. 17 shows a state before the inner surface IF of the case member 4 and the second fixing part 8P2 are separated by the impact or the like, and the right drawing of FIG. 17 shows a state when the inner surface IF of the case member 4 and the second fixing part 8P2 are separated by the impact or the like. In FIGS. 16 and 17, a cross pattern is attached to the adhesive AD4 for clarity.

As shown in in FIG. 16, the first front adhesive reservoir AC11 is configured such that the depth DH11 in the direction perpendicular to the inner surface IF (X-axis direction) is larger than the diameter DA2 of the second wire SA2. The second front adhesive reservoir AC12 is configured such that the depth DH12 in the direction perpendicular to the inner surface IF (X-axis direction) is larger than the diameter DA2 of the second wire SA2. n the illustrated example, the depth DH11 and the depth DH12 are the same size. The depth DH (the depth DH11 and the depth DH12) is represented by the distance from the inner surface IF when the inner surface IF and the first fixing part 8P1 are not separated for clarity.

This configuration has the effect that when the inner surface IF of the case member 4 and the first fixing part 8P1 are separated by the impact or the like, the second wire SA2 in a loosened state can be prevented from entering the gap DB1 formed between the inner surface IF and the first fixing part 8P1.

As shown in the bottom drawing of FIG. 16, even when the inner surface IF of the case member 4 and the first fixing part 8P1 are separated by the impact or the like, the adhesive AD4 cured in the front adhesive reservoir AC1 (the space formed by the front groove 8G1) typically remains adhered to the inner surface IF of the case member 4. In this case, even when the gap DB1 between the inner surface IF and the first fixing part 8P1 is larger than the diameter DA2 of the second wire SA2, larger than the depth DH11 of the first front adhesive reservoir AC11, and larger than the depth DH12 of the second front adhesive reservoir AC12, the gap CL1 between the adhesive AD4 adhered to the inner surface IF and the outer surface 8P1E of the first fixing part 8P1 is smaller than the diameter DA2 of the second wire SA2. Therefore, the adhesive AD4 adhered to the inner surface IF can prevent the loosened second wire SA2 from entering the gap DB1. The same applies to the adhesive AD4 cured in the rear adhesive reservoir AC3.

As shown in FIG. 17, the first left adhesive reservoir AC21 is configured such that the depth DH21 in the direction perpendicular to the inner surface IF (Y-axis direction) is larger than the diameter DA4 of the fourth wire SA4. The second left adhesive reservoir AC22 is configured such that the depth DH22 in the direction perpendicular to the inner surface IF (Y-axis direction) is larger than the diameter DA4 of the fourth wire SA4. In the illustrated example, the depth DH21 is larger than the depth DH22. For convenience, in the illustrated example, the depth DH (the depth DH21 and the depth DH22) is represented by the distance from the inner surface IF when the inner surface IF and the second fixing part 8P2 are not separated.

This configuration has the effect of preventing the loosened fourth wire SA4 from entering the gap DB2 formed between the inner surface IF and the second fixing part 8P2 when the inner surface IF of the case member 4 and the second fixing part 8P2 are separated by the impact or the like.

As shown in the right drawing of FIG. 17, even when the inner surface IF of the case member 4 and the second fixing part 8P2 are separated by the impact or the like, the adhesive AD4 cured in the left adhesive reservoir AC2 (the space formed by the left inclined part 8C2) typically remains adhered to the inner surface IF of the case member 4. In this case, even when the gap DB2 between the inner surface IF and the second fixing part 8P2 is larger than the diameter DA4 of the fourth wire SA4, the gap DB2 is smaller than the depth DH21 of the first left adhesive reservoir AC21 and smaller than the depth DH22 of the second left adhesive reservoir AC22. Therefore, the adhesive AD4 adhering to the inner surface IF can prevent the loosened fourth wire SA4 from entering the gap DB2. The same applies to the adhesive AD4 cured in the right adhesive reservoir AC4.

Thus, the adhesive AD4 cured in the adhesive reservoir AC can prevent the shape memory alloy wire SA from entering the gap DB between the inner surface IF of the case member 4 and the fixing part 8P even when the inner surface IF of the case member 4 and the fixing part 8P are separated by the impact or the like.

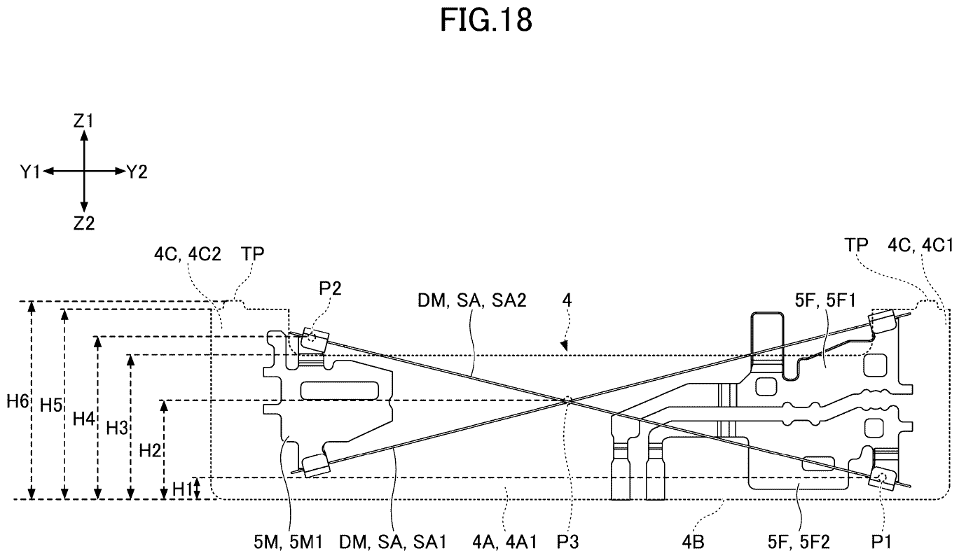

Next, referring to FIG. 18, the positional relation among the case member 4, the metal members 5, and the shape memory alloy wires SA will be described. FIG. 18 is a front view of the case member 4, the metal members 5, and the shape memory alloy wires SA. In FIG. 18, only an outline of the case member 4 is shown with a dashed line so that the positional relation among the metal members 5 (first movable terminal plate 5M1, first fixed terminal plate 5F1, and second fixed terminal plate 5F2) and the shape memory alloy wires SA (the first wire SA1 and the second wire SA2) arranged inside the case member 4 can be understood. In FIG. 18, members other than the first movable terminal plate 5M1, the first fixed terminal plate 5F1, the second fixed terminal plate 5F2, the first wire SA1, and the second wire SA2 are omitted for clarity. FIG. 18 shows the position of the movable metal member 5M (the first movable terminal plate 5M1) when the lens holding member 2 is in the initial state, and for convenience, the first wire SA1 and the second wire SA2 are shown in a state in which they are not loosened.

As shown in FIG. 18, the first point P1 at one end (fixed end) of the second wire SA2 positioned outside the first wire SA1 and the second point P2 at the other end (movable end) of the second wire SA2 have different heights in the vertical direction (Z-axis direction). The lower outer peripheral wall part 4A of the case member 4 extends to a position higher than the midpoint P3 between the first point P1 and the second point P2.

Specifically, the first point P1 is a point of height H1 at a position where one end (fixed end) of the second wire SA2 is fixed to the second fixed terminal plate 5F2. The height H1 is a height in the vertical direction (Z-axis direction) based on the bottom surface of the bottom plate 4B of the case member 4. The same applies to the heights H2 to H6 described below.

The second point P2 is a point of height H4 at a position where the other end (movable end) of the second wire SA2 is fixed to the first movable terminal plate 5M1.

A midpoint P3 between the first point P1 and the second point P2 is a point of height H2. In the illustrated example, the midpoint P3 is located at a position where the first wire SA1 in an unloosened state and the second wire SA2 in an unloosened state intersect when viewed from X1 direction. However, the midpoint P3 between the first point P1 and the second point P2 in the vertical direction (Z-axis direction) need not be at the same height as the position where the first wire SA1 in an unloosened state and the second wire SA2 in an unloosened state intersect.

Each of the four lower lateral plates (the first lower lateral plate 4A1 to the fourth lower lateral plate 4A4) constituting the lower outer peripheral wall part 4A of the case member 4 has a height H3 higher than the height H2 of the midpoint P3.

FIG. 18 shows that the first lower lateral plate 4A1 has a height H3 higher than the height H2 of the midpoint P3. This configuration can prevent a portion of the second wire SA2 lower than the midpoint P3 from being pinched between the upper outer peripheral wall part 3A of the cover member 3 and the base member 8 when the cover member 3 is attached to the case member 4. This is because the lower outer peripheral wall part 4A of the case member 4 is disposed between the upper outer peripheral wall part 3A and the base member 8.

As shown in FIG. 18, each of the four lower corner plates 4C (the first lower corner plate 4C1 to the fourth lower corner plate 4C4) constituting the lower outer peripheral wall part 4A of the case member 4 has a height H5 higher than the height H4 of the second point P2. Furthermore, each of the four lower corner plates 4C (the first lower corner plate 4C1 to the fourth lower corner plate 4C4) has a positioning projection TP used to position the cover member 3 with respect to the case member 4 in the vertical direction (Z-axis direction). The positioning projection TP is formed so as to have a height H6 higher than the height H5 of the lower corner plate 4C.

FIG. 18 shows that the second lower corner plate 4C2 has a height H5 higher than the height H4 of the second point P2, and that the positioning projection TP of the second lower corner plate 4C2 has a height H6 higher than the height H5.

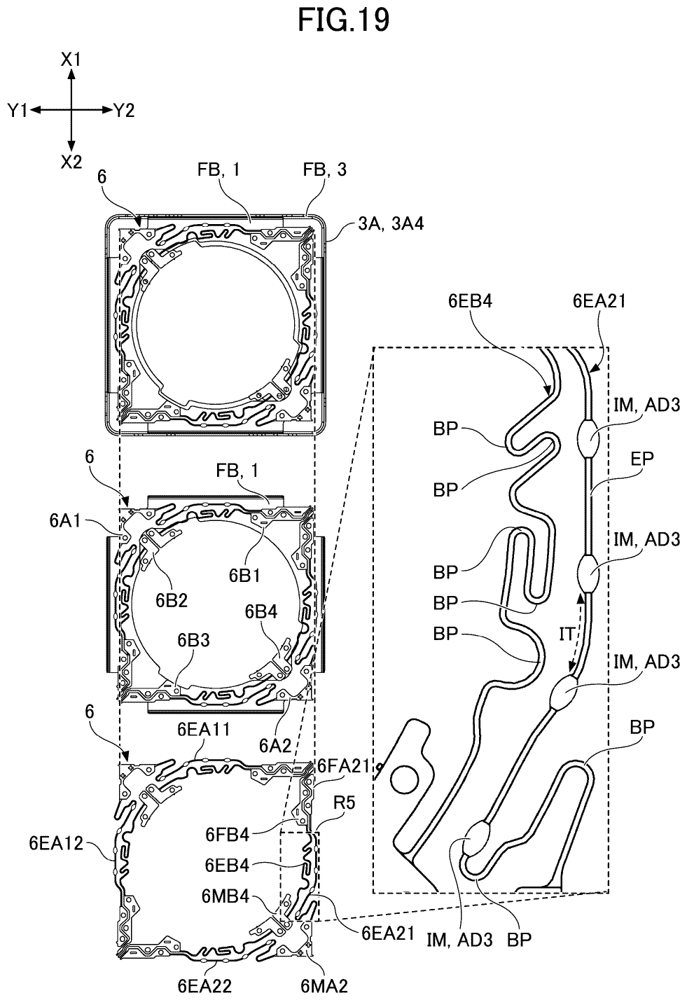

Next, referring to FIG. 19, the insulating member IM provided on the flat spring 6 will be described. FIG. 19 is a bottom view of the flat springs 6. Specifically, the top left drawing of FIG. 19 is a bottom view of the flat spring 6 arranged in the cover member 3 together with the plate member 1, the middle left drawing of FIG. 19 is a bottom view of the flat spring 6 arranged in the plate member 1, and the bottom left drawing of FIG. 19 is a bottom view of the flat spring 6 arranged alone. The right drawing of FIG. 19 is an enlarged view of the area R5 enclosed by a dashed line in the bottom left drawing of FIG. 19.

As shown in FIG. 19, the elastic arm 6EA21 of the second outer flat spring 6A2 and the elastic arm 6EB4 of the fourth inner flat spring 6B4 have portions adjacent to each other along the fourth upper lateral plate 3A4 of the cover member 3. In the portions adjacent to each other, the elastic arm 6EA21 is provided with adhesives AD3 serving as insulating members IM at four locations. The four adhesives AD3 are provided with an interval of a predetermined value

IT or more from each other. In the illustrated example, the four adhesives AD3 maintain a stretchable state so as not to hinder the elasticity of the flat spring 6. The adhesive AD3 constituting the insulating member IM may be made of a material other than the adhesive, such as a synthetic resin. The adhesive AD3 may be provided not on the elastic arm 6EA21 but on the elastic arm 6EB4, and may be provided on each of the elastic arm 6EA21 and the elastic arm 6EB4.

This configuration can prevent the elastic arm 6EA21 (the second outer flat spring 6A2) and the elastic arm 6EB4 (the fourth inner flat spring 6B4) from contacting each other and causing conduction (short circuit).

In the illustrated example, the adhesive AD3 as the insulating member IM is applied to each of the elastic arm 6EA11, the elastic arm 6EA12, the elastic arm 6EA21, and the elastic arm 6EA22 in four. In this case, the plate member 1 functioning as the insulating member IM may be omitted. This is because the adhesive AD3 can prevent the elastic arm 6EA21 from contacting the cover member 3 and conducting to the elastic arm 6EB4 via the cover member 3 even when the elastic arm 6EB4 contacts the cover member 3 when the plate member 1 is not provided. In this case, the adhesive AD3 may be provided to each of the elastic arms 6EB1 to 6EB4. This is because conduction between the two elastic arms is more reliably prevented.

As shown in FIG. 19, the elastic arm 6E is formed to have the flexed part BP and an extended part EP extending from the flexed part BP. In the example shown in FIG. 19, the flexed part BP is a portion that bends so as to reverse the direction in which the elastic arm 6E extends, and the extended part EP is a portion other than the flexed part BP. In the example shown in FIG. 19, the elastic arm 6EB4 has the five flexed parts BP, and the elastic arm 6EA21 has the two flexed parts BP. In the example shown in FIG. 19, the adhesive AD3 is provided on the extended part EP.

This configuration has an effect that the influence of the flat spring 6 on the spring constant is smaller than in the case where the insulating member IM is provided on the flexed part BP, that is, the adhesive AD3 is applied on the flexed part BP.

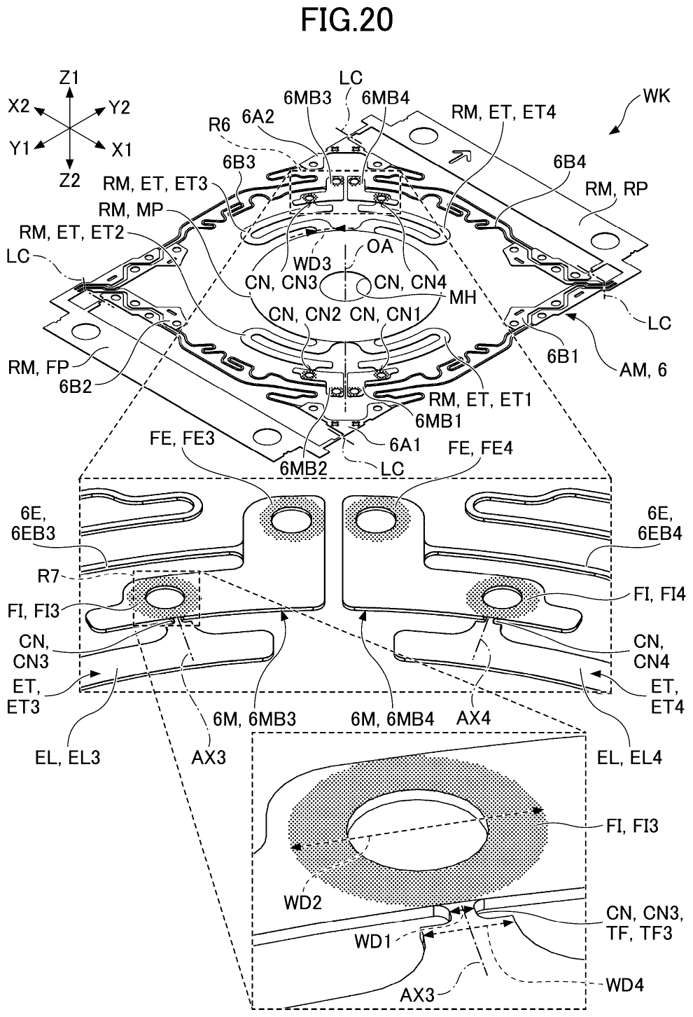

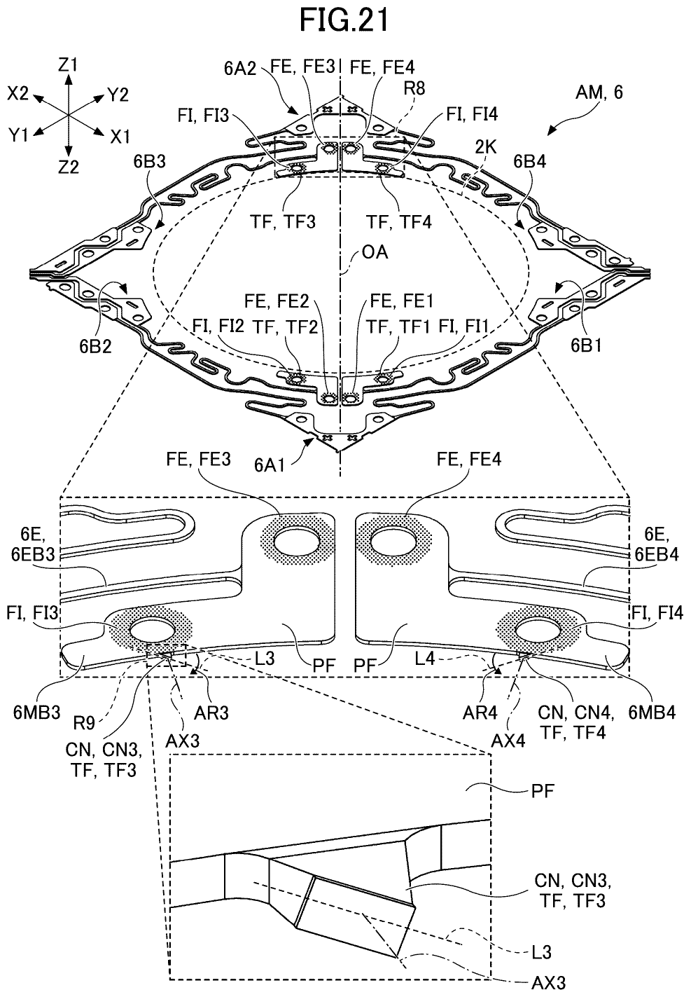

Next, referring to FIGS. 20 and 21, the workpiece WK including the flat spring 6 will be described. FIG. 20 is a perspective view of the workpiece WK. Specifically, the top drawing of FIG. 20 is a perspective view of an entirety of the workpiece WK. The middle drawing of FIG. 20 is an enlarged view of the area R6 surrounded by dashed lines in the top drawing of FIG. 20. The bottom drawing of FIG. 20 is an enlarged view of the area R7 surrounded by dashed lines in the middle drawing of FIG. 20. FIG. 21 is a perspective view of the flat springs 6 made of the workpiece WK. More specifically, the top drawing of FIG. 21 is a perspective view of an entirety of the flat spring 6 made of the workpiece WK. The middle drawing of FIG. 21 is an enlarged view of the area R8 enclosed by the dashed line in the top drawing of FIG. 21. The bottom drawing of FIG. 21 is an enlarged view of the area R9 enclosed by the dashed line in the middle drawing of FIG. 21.

The workpiece WK is a member used to make the flat spring 6 and is also referred to as a “work” and includes a removed part RM, a non-removed part AM (flat spring 6), and a connecting part CN. The removed part RM is a part removed from the workpiece WK in order to make the flat spring 6 from the workpiece WK and includes a main body MP, an elastic deformation part ET, a front removed part FP, and a rear removed part RP. The non-removed part AM is a portion remaining after the removed part RM is removed from the workpiece WK and corresponds to the flat spring 6 in the illustrated example.

The front removed part FP and the rear removed part RP are cut from the non-removed part AM by a cutting device (not shown). In the illustrated example, the front removed part FP and the rear removed part RP are cut from the non-removed part AM by irradiating a laser beam emitted by a laser cutting device (not shown) along the cutting line LC after the workpiece WK is attached to the lens holding member 2 and the base member 8.

The main MP and body the elastic deformation part ET are configured to collectively hold the movable supporting parts 6M of the four inner flat springs 6B before the removed part RM is removed from the workpiece WK.

In the illustrated example, the main body MP and the elastic deformation part ET are configured to be arranged inside the four inner flat springs 6B, that is, to be arranged inside the opening 2K of the lens holding member 2 when the workpiece WK is attached to the lens holding member 2. The main body MP is arranged inside the four elastic deformation parts ET. That is, the main body MP is connected to the four elastic deformation parts ET at its outer periphery.

Specifically, the main body MP is an annular portion having a circular hole MH at its center. The elastic deformation part ET is elastically deformed when the main body MP is moved in the optical axis direction. The elastic deformation includes a part ET first elastic deformation part ET1 corresponding to the movable supporting part 6MB1 of the first inner flat spring 6B1, a second elastic deformation part ET2 corresponding to the movable supporting part 6MB2 of the second inner flat spring 6B2, a third elastic deformation part ET3 corresponding to the movable supporting part 6MB3 of the third inner flat spring 6B3, and a fourth elastic deformation part ET4 corresponding to the movable supporting part 6MB4 of the fourth inner flat spring 6B4.

The connecting part CN is a portion that connects the removed part RM and the non-removed part AM. In the illustrated example, the connecting part CN is configured to connect the elastic deformation part ET, which is a portion of the removed part RM, and the movable supporting part 6M of the inner flat spring 6B, which is a portion of the non-removed part AM. The connecting part CN is configured to be partially removed together with the removed part RM.

In the illustrated example, the connecting part CN includes a first connecting part CN1 to connect the movable supporting part 6MB1 of the first inner flat spring 6B1 and the first elastic deformation part ET1, a second connecting part CN2 to connect the movable supporting part 6MB2 of the second inner flat spring 6B2 and the second elastic deformation part ET2, a third connecting part CN3 to connect the movable supporting part 6MB3 of the third inner flat spring 6B3 and the third elastic deformation part ET3, and a fourth connecting part CN4 to connect the movable supporting part 6MB4 of the fourth inner flat spring 6B4 and the fourth elastic deformation part ET4.

The movable supporting part 6M (movable supporting parts 6MB1 to 6MB4) of the inner flat spring 6B has an inner fixing part FI and an outer fixing part FE, which are portions fixed to the lens holding member 2. In the illustrated example, the inner fixing part FI and the outer fixing part FE are portions covered by the distal end portion of the protrusion 2T flattened by thermal caulking when the protrusion 2T formed on the upper surface of the lens holding member 2 is subjected to thermal caulking. In FIGS. 20 and 21, dot patterns are attached to the inner fixing part FI and the outer fixing part FE for clarity.

In the illustrated example, the inner fixing part FI is arranged adjacent to the connecting part CN, and the outer fixing part FE is arranged in the outer direction (further from the optical axis OA) of the inner fixing part FI. The elastic arm 6E of the inner flat spring 6B is configured to extend from between the inner fixing part FI and the outer fixing part FE. The width of the connecting part CN along the width direction perpendicular to the direction (extension direction) in which the connecting part CN extends is smaller than the width of the inner fixing part FI along the same width direction.

The elastic deformation part ET has an extended part EL extending in the direction intersecting the extension direction of the connecting part CN, as shown in the middle drawing of FIG. 20. In this case, a part of the extended part EL is positioned on the extension line inside the connecting part CN.

The elastic deformation part ET is formed in a substantially U-shape, and is configured such that one end thereof is connected to the connecting part CN and the other end thereof is connected to the main body MP. In this case, the width of the portion connected to the main body MP is larger than the width of the portion connected to the connecting part CN.

In the example shown in the middle drawing of FIG. 20, the movable supporting part 6MB3 of the third inner flat spring 6B3 has a third inner fixing part FI3 and a third outer fixing part FE3, and the movable supporting part 6MB4 of the fourth inner flat spring 6B4 has a fourth inner fixing part FI4 and a fourth outer fixing part FE4. The third inner fixing part FI3 is arranged adjacent to the third connecting part CN3, and the fourth inner fixing part FI4 is arranged adjacent to the fourth connecting part CN4. The elastic arm 6EB3 of the third inner flat spring 6B3 is configured to extend from between the third inner fixing part FI3 and the third outer fixing part FE3, and the elastic arm 6EB4 of the fourth inner flat spring 6B4 is configured to extend from between the fourth inner fixing part FI4 and the fourth outer fixing part FE4.

As shown in the bottom drawing of FIG. 20, the width WD1 of the third connecting part CN3 along the width direction perpendicular to the direction in which the third connecting part CN3 extends (the axial direction of the central axis AX3) is smaller than the width WD2 of the third inner fixing part FI3 along the same width direction. The same applies to the respective widths of the first connecting part CN1, the second connecting part CN2, and the fourth connecting part CN4.

As shown in the middle drawing of FIG. 20, the third elastic deformation part ET3 has a third extended part EL3 extending in the direction intersecting the extending direction of the third connecting part CN3 (the axial direction of the central axis AX3), and the fourth elastic deformation part ET4 has a fourth extended part EL4 extending in the direction intersecting the extending direction of the fourth connecting part CN4 (the axial direction of the central axis AX4). The same applies to the first elastic deformation part ET1 and the second elastic deformation part ET2.

Further, as shown in the top drawing of FIG. 20, the third elastic deformation part ET3 is formed in a substantially U-shape, and is configured such that one end (outer end) is connected to the third connecting part CN3 and the other end (inner end) is connected to the main body MP. In this case, the width WD3 of the portion connected to the main body MP is larger than the width WD4 of the portion connected to the third connecting part CN3 (see the bottom drawing of FIG. 20). The same applies to each of the first elastic deformation part ET1, the second elastic deformation part ET2, and the fourth elastic deformation part ET4.

A method of manufacturing a lens driving apparatus 100, which is an example of an optical component driving apparatus, includes a step of fixing a movable supporting part 6M (movable supporting parts 6MB1 to 6MB4) of an inner flat spring 6B to a lens holding member 2 so that a removed part RM (main body MP and elastic deformation part ET), which is a part of a workpiece WK, is positioned in an opening 2K of an optical component holding member (lens holding member 2), and a step of moving the main body MP in a direction intersecting the plate surface of the main body MP and twisting a connecting part CN provided inside the movable supporting part 6M to cut the connecting part CN.

Specifically, the main body MP has a hole MH for engaging a jig (not shown). The step of cutting the connecting part CN may include a step of pulling the main body MP upward by hooking the jig into the hole MH, a step of pushing the main body MP downward by hooking the jig into the hole MH, a step of pushing the main body MP upward by inserting the jig into the hole MH from below the main body MP, or a step of pushing the main body MP downward by inserting the jig into the hole MH from above the main body MP.

As shown in FIG. 21, a disconnecting part TF, which is a part of the disconnected connecting part CN, is left inside the movable supporting part 6M of the inner flat spring 6B. Specifically, as shown in the top drawing of FIG. 21, the disconnecting part TF includes a first disconnecting part TF1 which is a part of the first connecting part CN1 corresponding to the first inner fixing part FI1, a second disconnecting part TF2 which is a part of the second connecting part CN2 corresponding to the second inner fixing part FI2, a third disconnecting part TF3 which is a part of the third connecting part CN3 corresponding to the third inner fixing part FI3, and a fourth disconnecting part TF4 which is a part of the fourth connecting part CN4 corresponding to the fourth inner fixing part FI4.

In the illustrated example, the flat spring 6 has a combination (combination of the first inner fixing part FI1 and the second inner fixing part FI2 or combination of the third inner fixing part FI3 and the fourth inner fixing part FI4) of two inner fixing parts FI adjacent to each other. As shown in the middle drawing of FIG. 21, the tips of the third disconnecting part TF3 and the fourth disconnecting part TF4 are formed so as to be inclined in opposite directions to the plate surface PF of the movable supporting part 6M of the inner flat spring 6B.

Specifically, when the main body MP is moved upward with the workpiece WK (flat spring 6) fixed to the lens holding member 2 and the base member 8, the third connecting part CN3 is twisted and cut in the direction indicated by the arrow AR3 in FIG.

21, and the third disconnecting part TF3 as a part thereof remains inside the movable supporting part 6MB3. Similarly, the fourth connecting part CN4 is twisted and cut in the direction indicated by the arrow AR4 in FIG. 21, and the fourth disconnecting part TF4 as a part thereof remains inside the movable supporting part 6MB4.

That is, as shown in FIG. 21, the tip of the third disconnecting part TF3 is formed so as to be inclined in the direction indicated by the arrow AR3 with respect to the plate surface PF of the movable supporting part 6MB3. Similarly, the tip of the fourth disconnecting part TF4 is formed to incline in the direction indicated by the arrow AR4 with respect to the plate surface PF of the movable supporting part 6MB4. In FIG. 21, the inclination of the tip of the third disconnecting part TF3 is shown with a dashed line L3, and the inclination of the tip of the fourth disconnecting part TF4 is shown with a dashed line L4 for clarity. The dashed line L3 is a line parallel to the upper edge of the tip of the third disconnecting part TF3, and the dashed line L4 is a line parallel to the upper edge of the tip of the fourth disconnecting part TF4. However, the upper edge of the tip of the third disconnecting part TF3 need not be a perfect straight line. The same applies to the upper edge of the tip of the fourth disconnecting part TF4.

The direction indicated by the arrow AR3 and the direction indicated by the arrow AR4 are opposite to each other. Specifically, the direction indicated by the arrow AR3 is clockwise with respect to the central axis AX3 of the third connecting part CN3 (the third disconnecting part TF3) when viewed from the center (optical axis OA) of the opening 2K. The direction indicated by the arrow AR 4 is counterclockwise with respect to the central axis AX4 of the fourth connecting part CN4 (the fourth disconnecting part TF4) when viewed from the center (optical axis OA) of the opening 2K.

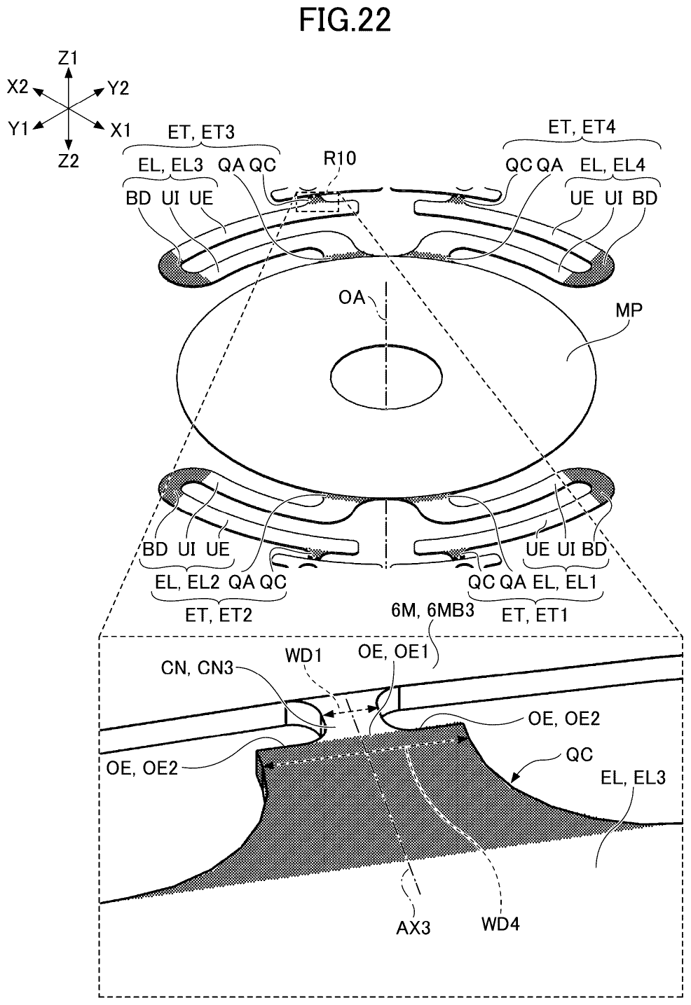

Next, with reference to FIG. 22, the removed part RM located inside the inner flat spring 6B will be described. FIG. 22 is a perspective view of a portion of the removed part RM constituting the workpiece WK. Specifically, the top drawing of FIG. 22 is a perspective view of the removed part RM located inside the inner flat spring 6B. The bottom drawing of FIG. 22 is an enlarged view of the area R10 surrounded by dashed lines in the top drawing of FIG. 22.

The removed part RM located inside the inner flat spring 6B includes a main body MP and four elastic deformation parts ET (first elastic deformation parts ET1 to fourth elastic deformation parts ET4). Each of the four elastic deformation parts ET (first elastic deformation parts ET1 to fourth elastic deformation parts ET4) includes an extended part EL, an inner connecting part QA, and an outer connecting part QC. Specifically, the first elastic deformation part ET1 includes a first extended part EL1, the second elastic deformation part ET2 includes a second extended part EL2, the third elastic deformation part ET3 includes a third extended part EL3, and the fourth elastic deformation part ET4 includes a fourth extended part EL4. Each of the four extended parts EL (first extended part EL1 to fourth extended part EL4) includes an inner extended part UI, an outer extended part UE, and the flexed part BD. In FIG. 22, dot patterns are attached to the inner connecting part QA, the outer connecting part QC, and the flexed part BD for clarity.

The inner connecting part QA is a portion that connects the extended part EL and the main body MP, and the outer connecting part QC is a portion that connects the extended part EL and the connecting part CN.

The inner extended part UI is positioned inside the outer extended part UE and is formed to extend along a circumference of a circle centered on the optical axis OA. The outer extended part UE is positioned outside the inner extended part UI and is formed to extend along the circumference of the circle centered on the optical axis OA. The flexed part BD is formed to connect the inner extended part UI and the outer extended part UE so that the inner extended part UI extends along the outer extended part UE.

In the example shown in the top drawing of FIG. 22, the inner extended part UI of the first elastic deformation part ET1 (first extended part EL1) extends in a counterclockwise direction from the inner connecting part QA along the circle centered on the optical axis OA, and the outer extended part UE of the first elastic deformation part ET1 (first extended part EL1) extends in a clockwise direction from the flexed part BD along the circle centered on the optical axis OA. Conversely, the inner extended part UI of the second elastic deformation part ET2 (second extended part EL2) extends in a clockwise direction from the inner connecting part QA along the circle centered on the optical axis OA, and the outer extended part UE of the second elastic deformation part ET2 (second extended part EL2) extends in a counterclockwise direction from the flexed part BD along the circle centered on the optical axis OA. Similarly, the inner extended part UI of the third elastic deformation part ET3 (third extended part EL3) extends in a counterclockwise direction from the inner connecting part QA along the circle centered on the optical axis OA, and the outer extended part UE of the third elastic deformation part ET3 (third extended part EL3) extends in a clockwise direction from the flexed part BD along the circle centered on the optical axis OA. Conversely, the inner extended part UI of the fourth elastic deformation part ET4 (fourth extended part EL4) extends in a clockwise direction from the inner connecting part QA along the circle centered on the optical axis OA, and the outer extended part UE of the fourth elastic deformation part ET4 (fourth extended part EL4) extends in a counterclockwise direction from the flexed part BD along the circle centered on the optical axis OA.

As shown in the bottom drawing of FIG. 22, the outer connecting part QC is formed so as to extend in both directions of the connecting part CN along a width direction that is perpendicular to the direction in which the connecting part CN extends (the radial direction of the circle centered on the optical axis OA). Specifically, the width of the outer connecting part QC along the width direction is larger than the width of the connecting part CN along the same width direction. The outer end OE of the outer connecting part QC has a first portion OE1 connected to the connecting part CN and a second portion OE2 located on both sides in the width direction of the first portion OE1 and not connected to the connecting part CN.

In the example shown in the lower diagram of FIG. 22, the outer connecting part QC of the third elastic deformation part ET3 (the third extended part EL3) is formed so as to extend on both sides of the third connecting part CN3 along the width direction that is perpendicular to the direction in which the third connecting CN3 extends part (the axial direction of the central axis AX3). Specifically, the width WD4 of the outer connecting part QC along the width direction is larger than the width WD1 of the third connecting part CN3 along the same width direction. The outer end OE of the outer connecting part QC has the first portion OE1 connected to the third connecting part CN3 and the second portion OE2 located on both sides in the width direction of the first portion OE1 and not connected to the third connecting part CN3. The same applies to the outer connecting parts QC of the first elastic deformation part ET1 (the first extended part EL1), the second elastic deformation part ET2 (the second extended part EL2), and the fourth elastic deformation part ET4 (the fourth extended part EL4).

As described above, the lens driving apparatus 100 according to the embodiment of the present disclosure, as shown in FIG. 2, includes the fixed member FB including the housing HS, the lens holding member 2 arranged inside the housing HS having the opening 2K penetrating therethrough in the vertical direction and accommodating the lens body LS therein, the plurality of flat springs 6 independent from each other provided so as to connect the upper portion of the lens holding member 2 and the fixed member FB in a state in which the lens holding member 2 can be moved relative to the fixed member FB, and the actuator DM for moving the lens holding member 2 relative to the fixed member FB. The housing HS includes the metal cover member 3 having the outer peripheral wall part (upper outer peripheral wall part 3A) and the top plate 3B. As shown in FIGS. 3 and 4, each of the plurality of flat springs 6 has the fixed supporting part 6F fixed to the fixed member FB, the movable supporting part 6M fixed to the upper portion of the lens holding member 2, and the elastically deformable elastic arm 6E provided so as to connect the fixed supporting part 6F and the movable supporting part 6M. The elastic arm 6E of each of the plurality of flat springs 6 is arranged so as to face the top plate 3B of the cover member 3. The insulating member IM is provided between the elastic arm 6E of each of the plurality of flat springs 6 and the top plate 3B. This configuration has the effect of preventing a short circuit of the plurality of flat springs 6. For example, when one of the plurality of flat springs 6 and another of the plurality of flat springs 6 form different electric paths, this configuration has the effect of preventing the short circuit of the two electric paths through the cover member 3.

As shown in FIG. 2, a metal plate member 1 as the insulating member IM may be fixed to the lower surface of the top plate 3B of the cover member 3. In this case, the insulating coating agent may be applied to the lower surface of the plate member 1. This configuration has the effect that the plate member 1 can be made thinner than when the plate member 1 is formed of the synthetic resin.

The outer peripheral wall part (upper outer peripheral wall part 3A) of the cover member 3 may have the four lateral plates (the first upper lateral plate 3A1 to the fourth upper lateral plate 3A4) as shown in FIG. 2. The plate member 1 may have the upper plate 1B facing the top plate 3B and the four bent parts 1A bent downward from the outer edge of the upper plate 1B. In this case, each of the four bent parts 1A may be configured to face the corresponding lateral plates (the first upper lateral plate 3A1 to the fourth upper lateral plate 3A4) of the cover member 3. This configuration has the effect that the positioning of the plate member 1 with respect to the cover member 3 is achieved by the bent parts 1A.

As shown in FIG. 2, the outer peripheral wall part (upper outer peripheral wall part 3A) of the cover member 3 may have the lateral plates (the first upper lateral plate 3A1 to the fourth upper lateral plate 3A4) positioned outside the elastic arm 6E of at least one of the plurality of flat springs 6. As shown in FIG. 2, the plate member 1 may have the upper plate 1B facing the top plate 3B of the cover member 3, and the bent part 1A bent downward from the outer edge of the upper plate 1B and arranged between the elastic arm 6E and the lateral plate (first upper lateral plate 3A1 to fourth upper lateral plate 3A4). The insulating coating agent may be applied to the inner surface of the bent part 1A. This configuration has the effect of preventing contact between the elastic arm 6E and the upper outer peripheral wall part 3A of the cover member 3 even when the elastic arm 6E of the flat spring 6 moves in the direction intersecting the vertical direction (Z-axis direction) due to the impact caused by dropping or the like of the lens driving apparatus 100.

As shown in FIG. 2, the plate member 1 may be fixed to the cover member 3 by the conductive adhesive AD1 and the insulating adhesive AD2. This configuration has the effect of making the potential of the plate member 1 equal to the potential of the cover member 3 (for example, a ground potential) by the conductive adhesive AD1, and increasing the adhesive strength between the plate member 1 and the cover member 3 by the insulating adhesive AD2. In the illustrated example, the cover member 3 is electrically connected to an external substrate or the like via the case member 4. Specifically, the cover member 3 is electrically connected to the external substrate or the like via a connection recess RS (see the upper drawing of FIG. 14) formed in the first lower lateral plate 4A1 of the case member 4 and functioning as the terminal part. The connection recess RS is a portion in which a part of the first lower lateral plate 4A1 is recessed inward. More specifically, as shown in the upper drawing of FIG. 14, the connection recess RS is electrically connected to the external substrate or the like by soldering, conductive adhesive, or the like, together with the respective terminal parts of the first conductive members CM1 to the fifth conductive members CM5, the first fixed terminal plate 5F1, and the second fixed terminal plate 5F2 exposed to the outside via the first through-hole 4H1 of the first lower lateral plate 4A1.

As shown in FIG. 19, the respective elastic arms 6E of the two flat springs 6 have portions adjacent to each other, and at least one of the two elastic arms 6E in the adjacent portions may be provided with the adhesive AD3 serving as the insulating member IM at a plurality of locations. In this case, the insulating member IM may be formed of a material other than the adhesive such as the synthetic resin. This configuration has the effect of prevent a short circuit between the two elastic arms even when the elastic arms 6E are undesirably deformed due to the impact caused by dropping or the like. Since the adhesive AD3 after curing does not have adhesiveness, it does not adhere to the adjacent elastic arms 6E when it comes into contact with the adjacent elastic arms 6E.

In the portion where the two elastic arms 6E are adjacent to each other, the adhesive AD3 may be provided on only one of the two elastic arms 6E or on both of the two elastic arms 6E as shown in FIG. 19. The configuration in which the adhesive AD3 is provided on only one of the two elastic arms 6E has the effect of improving production efficiency of the lens driving apparatus 100 as compared with the configuration in which the adhesive AD3 is provided on both of the two elastic arms 6E.

As shown in FIG. 19, the adhesive AD3 to prevent contact between the elastic arms 6E and the top plate 3B may be applied to a plurality of portions of the elastic arms 6E of the plurality of flat springs 6. In this case, the adhesive AD3 constitutes the insulating member IM. This configuration has the effect that contact between the elastic arm 6E and the top plate 3B can be prevented by a simple method of applying the adhesive AD3 to the elastic arm 6E. Since the adhesive AD3 after curing does not have adhesiveness, it does not adhere to the top plate 3B when it comes into contact with the top plate 3B.

As shown in FIG. 19, the elastic arm 6E may have the flexed part BP and the extended part EP extending from the flexed part BP. In this case, the insulating member IM may be provided in the extended part EP. This configuration has the effect that the influence on the spring constant of the flat spring 6 is smaller than when the insulating member IM is provided in the flexed part BP, that is, when the adhesive AD3 is applied to the flexed part BP.

Further, the lens driving apparatus 100 according to the embodiment of the present disclosure, as shown in FIG. 2, includes the base member 8, the optical component holding member (lens holding member 2) provided movably with respect to the base member 8 having the opening 2K penetrating therethrough in the vertical direction and accommodating the optical component (lens body LS) therein, the cover member 3 having the top plate 3B facing the base member 8 in the vertical direction, with the optical component holding member (lens holding member 2) interposed therebetween, the cover member 3 having the upper outer peripheral wall part 3A including the plurality of upper lateral plates (the first upper lateral plate 3A1 to the fourth upper lateral plate 3A4) extending downward from the outer edge of the top plate 3B, and the plurality of shape memory alloy wires SA arranged inside the upper outer peripheral wall part 3A, the end of each of which is fixed to the fixed member FB including the base member 8, the other end of each of which is fixed to the movable member MB including the optical component holding member (lens holding member 2), and which is configured to move the optical component holding member (lens holding member 2) with respect to the base member 8. The fixed member FB includes the case member 4 with an open top configured to house the base member 8. The case member 4 has the bottom plate 4B arranged at the bottom of the base member 8 and the lower outer peripheral wall part including the plurality of lower lateral plates (the first lower lateral plate 4A1 to the fourth lower lateral plate 4A4) extending upward from the outer edge of the bottom plate 4B. The lower lateral plates (the first lower lateral plate 4A1 to the fourth lower lateral plate 4A4) are positioned between the shape memory alloy wires SA and the upper lateral plates (the first upper lateral plate 3A1 to fourth upper lateral plate 3A4) constituting the upper outer peripheral wall part, and face the plurality of shape memory alloy wires SA. This configuration has the effect of reducing occurrence of defects caused by contact between the shape memory alloy wire SA and the cover member 3, such as the shape memory alloy wire SA being pinched between the base member 8 and the cover member 3 when the cover member 3 is assembled. This is because the lower outer peripheral wall part 4A of the case member 4 exists outside the shape memory alloy wire SA.

As shown in FIG. 18, the first point P1 at the position where the one end of the shape memory alloy wire SA is fixed to the fixed member FB and the second point P2 at the position where the other end of the shape memory alloy wire SA is fixed to the movable member MB may have different heights in the vertical direction. The lower lateral plates (the first lower lateral plate 4A1 to fourth lower lateral plate 4A4) may extend to the position higher than the midpoint P3 between the first point P1 and the second point P2. Since at least the lower half of the shape memory alloy wire SA can be covered with the case member 4, this configuration has the effect that the occurrence of a failure caused by contact between the shape memory alloy wire SA and the cover member 3 can be further reduced compared with the case where the height of the lower lateral plate is lower than the midpoint P3. It should be noted that the lower lateral plate is not limited to a configuration that is higher than the midpoint P3 over the entire area. For example, when there is a portion that does not face the shape memory alloy wire SA, the height of the lower lateral plate may be partially lower than the midpoint P3. The lower lateral plate may be configured such that portions higher than the midpoint P3 and portions lower than the midpoint P3 are alternately formed.

As shown in FIG. 2, the lower outer peripheral wall part 4A may have the lower corner plate 4C positioned between the adjacent two lower lateral plates. In this case, the lower corner plate 4C may extend to the position higher than the lower lateral plate as shown in FIG. 18. Since the position (downward movement) of the cover member 3 assembled to the case member 4 can be limited by the lower corner plate 4C, this configuration has the effect of further reducing the occurrence of defects caused by contact between the shape memory alloy wire SA and the cover member 3.

The cover member 3 and the case member 4 may be both formed of one or more metal plates, and may be electrically connected to each other. This configuration has the effect of achieving thinning of the cover member 3 and the case member 4 while maintaining strength of the cover member 3 and the case member 4 as compared with the cover member 3 and the case member 4 formed of a material other than metal, and consequently achieving miniaturization of the optical component driving apparatus. This configuration also has the effect of providing the optical component driving apparatus with a shield function.

As shown in FIG. 5, the one end of the shape memory alloy wire SA may be fixed to the fixed the metal member 5F provided in the base member 8. As shown in FIG. 5, the other end of the shape memory alloy wire SA may be fixed to the movable metal member 5M provided in the optical component holding member (lens holding member 2). As shown in the top drawing of FIG. 13, the fixed metal member 5F and the movable metal member 5M may face different portions of the lower outer peripheral wall part 4M in the direction perpendicular to the vertical direction. The base member 8 may be formed of the synthetic resin and have a fixing part bonded and fixed to the inner surface IF of the lower outer peripheral wall part 4A as shown in the bottom drawing of FIG. 13. As shown in FIGS. 14 and 15, the fixing part 8P may be arranged to adjoin the fixed metal member 5F, and have the adhesive reservoir AC formed of the groove 8G or the inclined part 8C formed so as to be separated from the inner surface IF of the lower outer peripheral wall part 4A. In this case, the shape memory alloy wire SA may be configured to extend over the fixing part 8P. That is, the fixing part 8P having the adhesive reservoir AC may be configured to be positioned below the shape memory alloy wire SA. The adhesive AD4 may be provided between the adhesive reservoir AC and the inner surface IF of the lower outer peripheral wall part 4A. With this configuration, as shown in FIGS. 16 and 17, even when the adhesive AD4 is separated from the base member 8 (fixing part 8P) due to the impact caused by dropping or the like and adheres only to the lower outer peripheral wall part 4A of the case member 4, and when the gap is generated between the base member 8 and the case member 4, the loosened shape memory alloy wire SA can be prevented from entering the gap. That is, this configuration has the effect of preventing the loosened shape memory alloy wire SA from being pinched between the base member 8 and the case member 4 in the case of an undesired state as described above.

The inclined part 8C constituting the adhesive reservoir AC need not be formed in a planar shape, but may be formed in a curved shape.

The adhesive reservoir AC may extend in the vertical direction as shown in FIGS. 14 and 15. In this case, as shown in FIGS. 16 and 17, the depth DH of the adhesive reservoir AC in the direction perpendicular to the inner surface IF of the lower outer peripheral wall part 4A (the first lower lateral plate 4A1 to the fourth lower lateral plate 4A4) to which the fixing part 8P is bonded is configured to be larger than the diameter of the shape memory alloy wire SA. This configuration has the effect that the adhesive AD (particularly, a hardened portion in the adhesive reservoir AC) adhered to the lower outer peripheral wall part 4A can prevent the loosened shape memory alloy wire SA from entering the gap between the base member 8 and the case member 4 even in the case of the above-described undesirable state. Therefore, this configuration has the effect that the loosened shape memory alloy wire SA can be further prevented from being pinched between the base member 8 and the case member 4.

In the above-described configuration, when the optical component holding member (lens holding member 2) is in the neutral state, as shown in the upper drawing of FIG. 13, the outer surface EF1 of the fixed metal member 5F may be disposed closer to the inner surface IF of the lower outer peripheral wall part 4A than is the outer surface EF2 of the movable metal member 5M. That is, even when the fixed metal member 5F is disposed closer to the lower outer peripheral wall part 4A than is the movable metal member 5M, the above-described configuration has the effect that the loosened shape memory alloy wire SA can be prevented from being pinched between the base member 8 and the case member 4.

As shown in FIG. 2, the lens driving apparatus 100 according to the embodiment of the present disclosure includes the fixed member FB, the optical component holding member (lens holding member 2) having the opening 2K penetrating therethrough in the vertical direction, the opening 2K being configured to accommodate the optical component (lens body LS) therein, the flat spring 6 having the fixed supporting part 6F provided so as to connect the optical component holding member (lens holding member 2) and the fixed member FB in a state where the optical component holding member (lens holding member 2) can be moved relative to the fixed member FB, the movable supporting part 6M fixed to the optical component holding member (lens holding member 2), and an elastically deformable elastic arm 6E provided so as to connect the fixed supporting part 6F and the movable supporting part 6M, and the actuator DM for moving the optical component holding member (lens holding member 2) relative to the fixed member FB. In the direction facing the opening 2K of the movable supporting part 6M, as shown in FIG. 21, there may be the disconnecting part TF which is a part of the connecting part CN connected to the removed part RM. In this case, the distal end of the disconnecting part TF may be shaped to be inclined with respect to the plate surface PF of the movable supporting part 6M. That is, the distal end of the disconnecting part TF may be formed to be twisted with respect to the plate surface PF. The reason why the distal end of the disconnecting part TF is inclined with respect to the plate surface PF is because the connecting part CN is twisted when the removed part RM is disconnected from the flat spring 6. This configuration has the effect that the production efficiency of the optical component driving apparatus can be improved as compared with the case where the connecting part is cut by bending a plurality of times.

As shown in FIG. 21, the movable supporting part 6M may have the inner fixing part FI provided adjacent to the outside of the disconnecting part TF. The inner fixing part FI is a portion to be fixed to the optical component holding member (lens holding member 2). In this case, the width WD1 of the disconnecting part TF (connecting part CN) is smaller than the width WD2 of the inner fixing part FI as shown in the bottom drawing of FIG. 20. This configuration has the effect that the removed part RM can be more reliably separated than the configuration in which the disconnecting part TF is provided at a position away from the inner fixing part FI.

The inner fixing part FI may be a portion fixed (pressed) by a caulking fixing part formed by inserting and caulking the protrusion 2T (see FIG. 3) formed in the optical component holding member (lens holding member 2) into the hole formed in the movable supporting part 6M. This configuration provides an effect that the inner flat spring 6B (movable supporting part 6M) can be fixed to the lens holding member 2 more easily and more reliably than fixing by the adhesive. However, fixing by the adhesive may be adopted as a fixing method between the optical component holding member (lens holding member 2) and the movable supporting part 6M.

As shown in the middle drawing of FIG. 21, the movable supporting part 6M may have the outer fixing part FE fixed to the optical component holding member (lens holding member 2). In this case, the inner fixing part FI may correspond to the disconnecting part TF (connecting part CN). The elastic arm 6E may extend from between the inner fixing part FI and the outer fixing part FE. This configuration has the effect that force acting on the movable supporting part 6M when the connecting part CN is cut can be prevented from adversely affecting the elastic arm 6E. When the elastic arm 6E extends from the portion of the movable supporting part 6M located near the inner fixing part FI, the outer fixing part FE may be omitted.

As shown in the upper drawing of FIG. 21, two of the plurality of disconnecting parts TF of the flat spring 6 may be provided at positions facing each other across the opening 2K. In the illustrated example, the first disconnecting part TF1 and the fourth disconnecting part TF4 of the flat spring 6 are provided at positions facing each other across the opening 2K. Similarly, the second disconnecting part TF2 and the third disconnecting part TF3 of the flat spring 6 are provided at positions facing each other across the opening 2K. This configuration has the effect of facilitating a separation of the removed part RM from the non-removed part AM (flat spring 6).

As shown in the top drawing of FIG. 21, the flat spring 6 may have the two adjacent inner fixing parts FI. In this case, the two disconnecting parts TF corresponding to the two adjacent inner fixing parts FI are formed so that their respective tips incline in opposite directions with respect to the plate surface PF of the movable supporting part 6M. In the example shown in FIG. 21, the flat spring 6 has the third inner fixing part FI3 and the fourth inner fixing part FI4 which are adjacent to each other. In this case, the tip of the third disconnecting part TF3 corresponding to the third inner fixing part FI3 is formed so as to incline in the direction indicated by the arrow AR3 with respect to the plate surface PF of the movable supporting part 6MB3. The distal end of the fourth disconnecting part TF4 corresponding to the fourth inner fixing part FI4 is formed to incline in the direction indicated by the arrow AR4 with respect to the plate surface PF of the movable supporting part 6MB4. The direction indicated by the arrow AR3 and the direction indicated by the arrow AR4 are opposite to each other. Specifically, the direction indicated by the arrow AR3 is clockwise with respect to the central axis AX3 of the third connecting part CN3 (the third disconnecting part TF3) when viewed from the center of the opening 2K. The direction indicated by the arrow AR4 is counterclockwise with respect to the central axis AX4 of the fourth connecting part CN4 (the fourth disconnecting part TF4) when viewed from the center of the opening 2K. In other words, the flat spring 6 may have the first flat spring and the second flat spring. In this case, the movable supporting part 6M of the first flat spring and the movable supporting part 6M of the second flat spring may be arranged so as to be adjacent to each other in the top view along the vertical direction. The disconnecting part TF corresponding to the movable supporting part 6M of the first flat spring and the disconnecting part TF corresponding to the movable supporting part 6M of the second flat spring may be formed so as to twist in the opposite direction with respect to the plate surface PF of the movable supporting part 6M. In the example shown in FIG. 20, the flat spring 6 has the third inner flat spring 6B3 as the first flat spring and the fourth inner flat spring 6B4 as the second flat spring. The movable supporting part 6MB3 of the third inner flat spring 6B3 and the movable supporting part 6MB4 of the fourth inner flat spring 6B4 are arranged so as to be adjacent to each other in the top view along the vertical direction. In this case, as shown in FIG. 21, the third disconnecting part TF3 corresponding to the movable supporting part 6MB3 of the third inner flat spring 6B3 and the fourth disconnecting part TF4 corresponding to the movable supporting part 6MB4 of the fourth inner flat spring 6B4 are formed so as s to twist in the opposite direction with respect to the plate surface PF of the movable supporting part 6M. This configuration provides the effect that the removed part RM can be easily separated even when the two inner fixing parts FI are adjacent to each other. In the illustrated example, the third inner flat spring 6B3 and the fourth inner flat spring 6B4 are separated from each other, but may be connected. That is, the third inner flat spring 6B3 and the fourth inner flat spring 6B4 may form one conductive path.

The method of manufacturing the optical component driving apparatus according to the embodiment of the present disclosure includes a step of fixing the movable supporting part 6M to the optical component holding member (lens holding member 2) so that the removed part RM, which is a part of the workpiece WK, is positioned in the opening 2K, and a step of moving the main body MP relative to the movable supporting part 6M in the direction intersecting the plate surface of the main body MP (substantially perpendicular direction), thereby twisting the connecting part CN provided inside the movable supporting part 6M, thereby cutting the connecting part CN. The inside of the movable supporting part 6M is connected to the removed part RM via the connecting part CN. The removed part RM includes the main body MP and the elastically deformable elastic deformation part ET provided between the main body MP and the connecting part CN. In this manufacturing method, the connecting part CN can be cut simply by moving the main body MP of the removed part RM relative to the non-removed part AM (flat spring 6). Therefore, this manufacturing method has the effect of improving the production efficiency of the optical component driving apparatus.

As shown in FIG. 20, the movable supporting part 6M may have the inner fixing part FI provided adjacent to the connecting part CN. The inner fixing part FI is a portion fixed to the optical component holding member (lens holding member 2). In this case, the width WD1 of the connecting part CN along the width direction perpendicular to the direction in which the connecting part CN extends is smaller than the width WD2 of the inner fixing part FI along the width direction, as shown in the lower diagram of FIG. 20. This configuration has the effect that the removed part RM can be more reliably separated from the non-removed part AM (flat spring 6) than the configuration in which the connecting part CN is provided at a position remote from the inner fixing part FI.

The elastic deformation part ET may have the extended part EL extending in the direction intersecting the extension direction of the connecting part CN. In this case, a part of the extended part EL may be located on the extension line inside the connecting part CN. In the example shown in FIG. 20, the third elastic deformation part ET3 has the third extended part EL3 extending in the direction intersecting the extension direction (axial direction of the central axis AX3) of the third connecting part CN3. In this case, a part of the third extended part EL3 is located on the extension line (axial line of the central axis AX3) inside the third connecting part CN3. This configuration provides the effect that generated stress when the elastic deformation part ET is elastically deformed can be concentrated in the connecting part CN.

As shown in the top drawing of FIG. 20, the elastic deformation part ET may be formed in a U-shape, and one end thereof may be connected to the connecting part CN and the other end thereof may be connected to the main body MP. In this case, the width WD3 of the portion connected to the main body MP is larger than the width WD4 of the portion connected to the connecting part CN (see the bottom drawing of FIG. 20). In other words, as shown in FIG. 22, the extended part EL of the elastic deformation part ET may have the flexed part BD, the outer extended part UE connected to one end of the flexed part BD, and the inner extended part UI connected to the other end of the flexed part BD and extending along the outer extended part UE. In this case, the inner extended part UI may be connected to the main body MP through a portion (inner connecting part QA) having a width larger than the width of the connecting part CN. This configuration has the effect that stress generated when the elastic deformation part ET is elastically deformed can be concentrated in the connecting part CN.

As shown in the bottom drawing of FIG. 22, the elastic deformation part ET may have the outer connecting part QC connecting the extended part EL and the connecting part CN between the extended part EL and the connecting part CN. In this case, the width WD4 of the outer connecting part QC along the width direction that is perpendicular to the direction in which the connecting part CN extends (the axial direction of the central axis AX3) is larger than the width WD1 of the connecting part CN along the same width direction. The outer end OE of the outer connecting part QC has the first portion OE1 connected to the connecting part CN and the second portion OE2 located on both sides of the first portion OE1 in the width direction and not connected to the connecting part CN. This configuration has the effect that the connecting part CN is more securely twisted, so that the removed part RM can be more securely separated from the non-removed part AM (flat spring 6) in the connecting part CN.

As shown in the top drawing of FIG. 20, the workpiece WK may include two connecting parts CN facing each other across the main body MP. In this case, each of the two connecting parts CN is connected to the inside of the corresponding movable supporting part 6M. In the illustrated example, the workpiece WK includes first connecting parts CN1 and fourth connecting parts CN4 facing each other across the main body MP, and second connecting parts CN2 and third connecting parts CN3 facing each other across the main body MP. In this case, the first connecting part CN1 is connected to the inside of the corresponding movable supporting part 6MB1. The second connecting part CN2 is connected to the inside of the corresponding movable supporting part 6MB2. The third connecting part CN3 is connected to the inside of the corresponding movable supporting part 6MB3. The fourth connecting part CN4 is connected to the inside of the corresponding movable supporting part 6MB4. This configuration has the effect that the connecting part CN is more likely to be twisted, and consequently, the connecting part CN becomes more likely to be cut. In this configuration, when the main body MP is moved in the vertical direction, the pair of connecting parts CN (the first connecting part CN1 and the fourth connecting part CN4) facing each other across the main body MP are twisted in the opposite directions, and the other pair of connecting parts CN (the second connecting part CN2 and the third connecting part CN3) facing each other across the main body MP are twisted in the opposite directions. This is also because the adjacent pair of connecting parts CN (the first connecting part CN1 and the second connecting part CN2) are twisted in the opposite directions, and the adjacent other pair of connecting parts CN (the third connecting part CN3 and the fourth connecting part CN4) are twisted in the opposite directions.

The hole MH may be formed in the main body MP. In this case, the step of cutting the connecting part CN may include a step of moving the main body MP by engaging a jig (not shown) with the hole MH. Specifically, the step of cutting the connecting part CN may include a step of pulling up the main body MP by hooking the jig with the hole MH, or a step of pushing up the main body MP by inserting the jig into the hole MH from below the main body MP. This configuration has the effect that the main body MP can be easily moved by using the hole MH formed in the main body MP. Therefore, this configuration has the effect that the connecting part CN can be easily twisted, and consequently, the removed part RM can be easily separated from the non-removed part AM (flat spring 6).

Further, the present invention is not limited to the embodiment, but various variations and modifications may be made without departing from the scope of the present invention.

For example, in the embodiment described above, the outer flat spring 6A is utilized as the conductive path to the shape memory alloy wire SA and the inner flat spring 6B is utilized as the conductive path to the electrical device, while the inner flat spring 6B is utilized as the conductive path to the shape memory alloy wire SA and the outer flat spring 6A is utilized as the conductive path to the electrical device.

Also, in the embodiment described above, the fixed metal member 5F is fixed to the base member 5 8 by the adhesive, but may be embedded in the base member 8 or may be the conductive pattern formed on the surface of the base member 8. Similarly, the movable metal member 5M is fixed to the lens holding member 2 by the adhesive, but may be embedded in the 10 lens holding member 2 or may be the conductive pattern formed on the surface of the lens holding member 2.

What is claimed is:

1. An optical component driving apparatus comprising:
a base member;
an optical component holding member provided movably with respect to the base member having an opening penetrating therethrough in a vertical direction, the opening being configured to accommodate an optical component therein;
a cover member having a top plate facing the base member in the vertical direction, with the optical component holding member interposed therebetween, the cover member having an upper outer peripheral wall part including a plurality of upper lateral plates extending downward from an outer edge of the top plate; and
a plurality of shape memory alloy wires arranged inside the upper outer peripheral wall part, an end of each of which being fixed to a fixed member including the base member, another end of each of which being fixed to a movable member including the optical component holding member, and each of which being configured to move the optical component holding member with respect to the base member,
wherein the fixed member includes a case member with an open top configured to house the base member,
wherein the case member has a bottom plate arranged at a bottom of the base member and a lower outer peripheral wall part including a plurality of lower lateral plates extending upward from an outer edge of the bottom plate, and
wherein the plurality of lower lateral plates are positioned between the plurality of shape memory alloy wires and the plurality of upper lateral plates constituting the upper outer peripheral wall part, and face the plurality of shape memory alloy wires.

2. The optical component driving apparatus according to claim 1, wherein:
for each of the plurality of shape memory alloy wires, a first point at a position where the one end is fixed to the fixed member and a second point at a position where the other end is fixed to the movable member have different heights in the vertical direction; and
the plurality of lower lateral plates extend to a position higher than a midpoint between the first point and the second point.

3. The optical component driving apparatus according to claim 1, wherein the lower outer peripheral wall part has a corner plate positioned between adjacent two of the plurality of lower lateral plates, and wherein the corner plate extends to a position higher than the plurality of lower lateral plates.

4. The optical component driving apparatus according to claim 1, wherein the cover member and the case member are both formed of one or more metal plates, and are electrically connected to each other.

5. The optical component driving apparatus according to claim 1, wherein:
the one end of each of the plurality of shape memory alloy wires is fixed to a fixed metal member provided in the base member;
the other end of each of the plurality of shape memory alloy wires is fixed to a movable metal member provided in the optical component holding member;
the fixed metal member and the movable metal member face different portions of the lower outer peripheral wall part in a direction perpendicular to the vertical direction;
the base member is formed of a synthetic resin and has a fixing part bonded and fixed to an inner surface of the lower outer peripheral wall part;
the fixing part is arranged to adjoin the fixed metal member, and has an adhesive reservoir formed of a groove or an inclined part formed so as to be separated from the inner surface of the lower outer peripheral wall part;
the plurality of shape memory alloy wires extend over the fixing part, and
an adhesive is provided between the adhesive reservoir and the inner surface of the lower outer peripheral wall part.

6. The optical component driving apparatus according to claim 5, wherein:
the adhesive reservoir extends in the vertical direction; and
a depth of the adhesive reservoir in a direction perpendicular to the inner surface of the lower outer peripheral wall part to which the fixing part is bonded is greater than a diameter of any one of the plurality of shape memory alloy wires.

7. The optical component driving apparatus according to claim 5, wherein when the optical component holding member is in a neutral state, an outer surface of the fixed metal member is arranged at a position closer to the inner surface of the lower outer peripheral wall part than is an outer surface of the movable metal member.

8. A camera module comprising:
the optical component driving apparatus of claim 1;
a lens body as the optical component held by the optical component holding member; and
an imaging sensor arranged so as to face the lens body.
